(19) United States
(12) Patent Application Publication
(10) Pub. No.: US 2026/0128768 A1
(43) Pub. Date: May 7, 2026

(54) MULTI-LINK OPERATION ASSISTED SECTOR LEVEL SWEEP PROCEDURE FOR MMWAVE LINK

(71) Applicant: NXP USA, Inc., AUSTIN, TX (US)

(72) Inventors: Xiayu Zheng, San Jose, CA (US); Liwen Chu, San Ramon, CA (US); Rui Cao, Sunnyvale, CA (US); Hongyuan Zhang, Fremont, CA (US)

(21) Appl. No.: 19/365,068

(22) Filed: Oct. 21, 2025

Related U.S. Application Data
(60) Provisional application No. 63/714,927, filed on Nov. 1, 2024.

(51) Int. Cl. H04B 7/0456; H04B 7/0426

(52) U.S. Cl. CPC H04B 7/0456; H04B 7/043

(57) ABSTRACT

A wireless communication method, system, and apparatus perform analog beamforming training by generating training control information regarding a mmWave link between an AP MLD and a non-AP MLD, where the training control information includes a value to indicate if the non-AP MLD includes a directional receiver or an omni-directional receiver, where the AP MLD transmits a training PPDU sequence to the non-AP MLD through the mmWave link under control of the training control information, and then receives a first signal quality feedback message from the non-AP MLD through the non-mmWave link in response to the non-AP MLD detecting and measuring a first signal quality measure based on the training PPDU sequence received by the non-AP MLD under control of the training control information, where the AP MLD uses the first signal quality measure to determine antenna weight vectors for analog beamforming ranking of the AP MLD.

### CROSS-REFERENCE TO RELATED APPLICATION AND PRIORITY CLAIM

This application claims the benefit of U.S. Provisional Patent Application No. 63/714,927 entitled “MLO Assisted Sector Level Sweep Procedure for mmWave Link” filed Nov. 1, 2024, which is incorporated by reference in its entirety as if fully set forth herein.

### BACKGROUND

### Field

The present disclosure is directed in general to communication networks. In one aspect, the present disclosure relates generally to wireless local area network (WLAN) implementing the Institute of Electrical and Electronics Engineers (IEEE) 802.11 standard and any other standards and/or networks that can provide wireless transfer of data over a millimeter wave link.

### Description of the Related Art

An ever-increasing number of relatively inexpensive, low power wireless data communication services, networks and devices have been made available over the past number of years, promising near wire speed transmission and reliability. Enabling technology advances in the area of wireless communications, various wireless technology standards (including for example, the IEEE Standards 802.11a/b/g, 802.11n, 802.11ad, 802.11ac, 802.11ax, 802.11ay, and 802.11be and their updates and amendments, as well as the IEEE Standard 802.11bq now in the process of being developed) have been introduced that are known to persons skilled in the art and are collectively incorporated by reference as if set forth fully herein fully. For example, the 802.11be amendment to the IEEE 802.11 standard (“Wi-Fi 7”) added support for Multi-Link Operation (MLO). This feature increases capacity by simultaneously sending and receiving data across different frequency bands and channels (e.g., 2.4 GHz, 5 GHz, and 6 GHz). With MLO, for example, an access point multi-link device (AP MLD) simultaneously establishes multiple links with a non-AP MLD client over more than one frequency band in order to increases throughput, reduce latency, and improve reliability. Multi-Link Operation also supports various operating modes.

Another advance with wireless communications was proposed in the 802.11ad, 802.11ay, and 802.11aj standards which defined wireless communication standards in the 60 GHz or 45 GHz (China) mmWave band. In this area, the beamforming with a large number of antennas is identified as one of the most important mechanism in mmWave bands to compensate for the high pathloss for directional multi-gigabit communication (DMG, e.g., see P802.11-REVme/D4.0, August 2023). To balance the trade-off between cost and performance, the implementation of beamforming is composed of both analog beamforming and/or digital beamforming (or hybrid beamforming for MIMO case) for DMG beamforming. In the existing DMG approach for mmWave communication link signaling, there is an initial sector level sweep (SLS) phase to find the transmit and receive antenna weight vectors (AWV) for analog beamforming to enable the AP and STA to communicate, where the AP is the SLS initiator and the SLS is usually conducted periodically based on the beacon interval. In addition, there is a beam refinement protocol (BRP) phase to further train the device's receive and transmit antenna array(s) and improve its transmit (Tx) and receive (Rx) antenna configuration on top of SLS using an iterative procedure with BRP frame. When multiple Tx/Rx RF chains (each connecting to an antenna array) are enabled, the digital beamforming training could be further conducted once the analog beaming with BRP procedure is done and the analog AWVs are applied on both Tx/Rx RF chains. Under the existing DMG approach for mmWave communication link signaling, all the beamforming training packet exchanges are conducted in the mmWave band as a standalone mode. In addition, a special control PHY is required that is defined with 15 dB sensitivity margin over the lowest MCS to assist the training procedure, which also complicates the beamforming protocol design. As seen from the foregoing, there are performance vs. complexity vs. hardware cost trade-offs with the existing DMG approach for mmWave communication link signaling which are non-trivial to solve, and as a result, these standards with the DMG approach are not widely adopted in the market due to the complexity and high cost.

### BRIEF DESCRIPTION OF THE DRAWINGS

The present invention may be understood, and its numerous objects, features and advantages obtained, when the following detailed description of a preferred embodiment is considered in conjunction with the following drawings.

FIG. 1 is a simplified block diagram of a multi-link communications system in accordance with selected embodiments of the present disclosure.

FIG. 2 is a simplified block diagram of a wireless communications system in accordance with selected embodiments of the present disclosure.

FIG. 3 illustrates an example of a frame exchange sequence for an MLO-assisted SLS procedure for establishing a mmWave link with an omni-directional receiver and transmitter which have TX/RX beam reciprocity where a responder feedback message is provided at the non-mmWave link after a negotiated time in accordance with selected embodiments of the present disclosure.

FIG. 4 illustrates an example of a frame exchange sequence for an MLO-assisted SLS procedure for establishing a mmWave link with an omni-directional receiver and transmitter which have TX/RX beam reciprocity where a responder feedback message is provided at the non-mmWave link in response to an initiator poll request in accordance with selected embodiments of the present disclosure.

FIG. 5 illustrates an example of a frame exchange sequence for an MLO-assisted SLS procedure for establishing a mmWave link with an omni-directional receiver and transmitter which do not have TX/RX beam reciprocity where both the initiator and responder separately send feedback at the non-mmWave link in accordance with selected embodiments of the present disclosure.

FIG. 6 illustrates an example of a frame exchange sequence for an MLO-assisted SLS procedure for establishing a mmWave link with an omni-directional receiver and transmitter which do not have TX/RX beam reciprocity where the initiator and responder sequentially provide feedback at the non-mmWave link in response to an initiator poll request in accordance with selected embodiments of the present disclosure.

FIG. 7 illustrates an example of a frame exchange sequence for an MLO-assisted SLS procedure for establishing a mmWave link with an omni-directional receiver and transmitter which do not have TX/RX beam reciprocity where the initiator and responder send separate poll requests to solicit separate feedback from the responder and initiator at the non-mmWave link in accordance with selected embodiments of the present disclosure.

FIG. 8 illustrates an example of a frame exchange sequence for an MLO-assisted SLS procedure for establishing a mmWave link with a directional receiver and transmitter which do have TX/RX beam reciprocity where a responder feedback message is provided at the non-mmWave link after a negotiated time in accordance with selected embodiments of the present disclosure.

FIG. 9 illustrates an example of a frame exchange sequence for an MLO-assisted SLS procedure for establishing a mmWave link with a directional receiver and transmitter which have TX/RX beam reciprocity where the initiator sends the training PPDU transmission rounds on the mmWave link with separate initiator poll requests to trigger the responder to switch receive beams and where the responder provides feedback at the non-mmWave link in response to an initiator poll request after each training PPDU transmission round in accordance with selected embodiments of the present disclosure.

FIG. 10 illustrates an example of a frame exchange sequence for an MLO-assisted SLS procedure for establishing a mmWave link with a directional receiver and transmitter which have TX/RX beam reciprocity where the initiator sends a plurality of training PPDU transmission rounds on the mmWave link without separate poll requests to trigger the responder to switch receive beams and where the responder provides feedback at the non-mmWave link in response to an initiator poll request after the plurality of training PPDU transmission rounds in accordance with selected embodiments of the present disclosure.

FIG. 11 illustrates an example of a frame exchange sequence for an MLO-assisted SLS procedure for establishing a mmWave link with a directional receiver and transmitter which do not have TX/RX beam reciprocity where the responder sends feedback at the non-mmWave link after the initiator sends the training PPDU transmission rounds on the mmWave link and where the initiator sends feedback at the non-mmWave link after the responder sends the training PPDU transmission rounds on the mmWave link in accordance with selected embodiments of the present disclosure.

FIG. 12 illustrates an example of a frame exchange sequence for an MLO-assisted SLS procedure for establishing a mmWave link with a directional receiver and transmitter which do not have TX/RX beam reciprocity where the receiver sends feedback at the non-mmWave link in response to a transmitter poll request on the non-mmWave link after each training PPDU transmission round and where the transmitter sends feedback at the non-mmWave link in response to a receiver poll request on the non-mmWave link after each training PPDU transmission round in accordance with selected embodiments of the present disclosure.

FIG. 13 illustrates a flow diagram of a technique for wireless communications in accordance with selected embodiments of the present disclosure.

### DETAILED DESCRIPTION

A system, apparatus, and methodology are described for an analog beam training sector level sweep procedure for establishing a mmWave link between a first wireless multi-link device (MLD) and a second wireless MLD by transmitting at least a first setup frame over a non-mmWave link between the first and second wireless MLDs, where the first setup frame includes one or more training parameters for a sector level sweep (SLS) training PPDU sequence that is transmitted by the first wireless MLD over the mmWave link to the second wireless MLD, where the one of the training parameters is an indicator if the second wireless MLD is a directional or (quasi)omni-directional receiver. In selected embodiments, the first wireless MLD is an access point (AP) MLD (initiator), the second wireless MLD is a non-AP MLD (responder), and the one or more training parameters include the number of training PPDU/Beams, the transmit sector sweep (TXSS) configuration and/or the receive sector sweep (RXSS) configuration, and an indicator if the second wireless MLD is a directional or omni-directional receiver. After transmitting the first setup frame and waiting for a predetermined delay, the first wireless MLD transmits the SLS training PPDU sequence over the mmWave link to the second wireless MLD in accordance with the one or more training parameters. In response, the second wireless MLD receives, detects, and measures an SLS training PPDU signal quality to determine a transmit beam ranking for the first wireless MLD. The second wireless MLD further transmits, via the non-mmWave link, beam training feedback information regarding the SLS training PPDU sequence. In selected embodiments, the feedback containing the transmit beam ranking may be sent via non-mmWave link at the initiation of the second wireless MLD that received the SLS training PPDU sequence or in response to a beamforming (BF) poll packet sent by the first wireless MLD over the non-mmWave link.

The various implementations described in the following description relate generally to millimeter wave (mmWave) and non-mmWave communications to support new wireless communication protocols, and more particularly to a procedure for establishing a mmWave link that is supported by a multi-link operation device to overcome the limitations and drawbacks of conventional standalone mmWave link sector level sweep (SLS) procedures associated with the IEEE 802.11ay or 802.11ad amendments. It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

In embodiments of a wireless communications system, an access point (AP) affiliated with an AP multi-link device (MLD) (e.g., wireless device) of a wireless local area network (WLAN) transmits data to at least one associated non-AP station (STA) affiliated with a non-AP STA MLD (e.g., a STA MLD). The AP MLD is configured to operate with associated non-AP MLDs according to a communication protocol. For example, the communication protocol may be an Ultra-High Reliability (UHR) communication protocol, IEEE 802.11be communication protocol, or future versions of such protocols that are being developed. Features of wireless communications and multi-link communication systems operating in accordance with the UHR communication protocol and/or next-generation communication protocols may incorporate support for operation in the millimeter-wave (mmWave) frequency bands, specifically the unlicensed bands between 42 GHz and 71 GHz, into mainstream Wi-Fi.

To support the use of mmWave frequency bands, the IEEE 802.11bq standard, also known as Integrated Millimeter Wave (IMMW), is a planned amendment to the IEEE 802.11 Wi-Fi standard which will incorporate support for operation in mmWave links to meet the demands of new applications, including but not limited to augmented and virtual reality, proximity ranging and sensing, both in terms of throughput, latency bounds and accuracy for the next generation WLAN. The primary goal of this amendment is to incorporate support for operation in the millimeter-wave (mmWave) frequency bands, specifically the unlicensed bands between 42 GHz and 71 GHz, into mainstream Wi-Fi. The direction for the IEEE 802.11bq standard is to minimize system complexity and simplify integration by expanding the multi-link operation (MLO) defined in the sub-7 GHz band (non-mmWave link) specification to incorporate support for operation in the millimeter-wave (mmWave) frequency bands, specifically the unlicensed bands between 42 GHz and 71 GHz, into mainstream Wi-Fi.

To support operation in the mmWave bands, the 802.11bq standard will be designed to enable “non-standalone operation,” meaning that a device supporting 802.11bq must be able to operate in the mmWave frequency band (e.g., 45 GHz or 60 GHz) and must also be able to operate at least one of the sub-7 GHz unlicensed bands (like 2.4 GHz, 5 GHz, and 6 GHz). It does so by leveraging or reusing existing Physical Layer (PHY) and Medium Access Control (MAC) specifications from the sub-7 GHz bands while also defining new bandwidth modes and coexistence mechanisms to work effectively in the higher mmWave frequencies. In addition, the IEEE 802.11bq standard will modify and improve the frame exchange procedures used to perform mmWave sector level sweep (SLS) training (also referred to as “sector sweep training” and “sector sweep”). In particular, persons skilled in the art will appreciate that beamforming by sector sweeping is used to determine a transmission beamforming pattern to be applied by a first wireless device when transmitting data to a second wireless device. For example, the first wireless device can transmit training packets to the second wireless device, where the first wireless device can apply a different beamforming pattern when transmitting each training packet. In response, the second device generally determines which of the training packets had the highest quality (e.g., having the highest signal-to-noise ratio (SNR) and/or the lowest bit error rate (BER)) and notifies the first wireless device, which can then utilize the transmission beamforming pattern that yielded the highest quality packet. Similarly, to determine a reception beamforming pattern to be applied by the first wireless device when receiving data from the second wireless device, the second wireless device transmits training packets to the first wireless device, and the first wireless device applies a different beamforming pattern when receiving each training packet. The first wireless device may determine which of the training packets has the highest quality and utilize the reception beamforming pattern that yields the highest quality packet.

While the “SLS” terminology used to describe the initial beam acquisition procedure may change in future standards or revisions, the following terminology from the existing IEEE 802.11ay or 802.11ad standards will be used herein to describe the procedure for establishing the mmWave link by sweeping through various AWVs or beams corresponding to different sectors:
AWV (antenna weight vector)/Beam: A vector of weights describing the excitation (amplitude and phase) for each element of an antenna array. As used herein, AWV and beam may be used interchangeably.
Sector: A transmit or receive antenna pattern corresponding to a sector identifier (ID), one or multiple AWVs can be used to cover a sector, and we assume one AWV per sector later
Antenna array: An antenna array could be configured to cover overlapping or non-overlapping sectors.
RF chain: Each RF chain could connect to one or multiple antenna arrays in the implementation, but only one antenna array is connected to the RF chain at a time; multiple RF chains can be used to transmit one or multiple data streams. In the later discussion, we may assume one RF chain is equivalent to an antenna array.
Beam index: Indicates one AWV of the RF chain or a Tx/Rx AWV pair for the corresponding Tx/Rx RF chain pair.
SLS initiator: The STA that initiates the SLS procedure.
SLS responder: The recipient STA of the SLS initiator training PPDU.

With existing standalone mmWave link SLS procedures which are limited by the transmit sector sweep (TXSS) only procedure, a special high-sensitivity control PHY design is required to compensate for the gap between Tx beamforming (BF) gain only versus the BF gain with best Tx/Rx AWV pair. To address this limitation and to simplify overall beamforming training procedure in mmWave link operation for wide market adoption, there have been proposals for non-standalone operations in unlicensed mmWave bands between 42 GHz and 71 GHz by using sub-7 GHz unlicensed bands, but such proposals typically do not take into account whether a directional receiver or omni-directional receiver is used when performing an RX AWV sweep. For example, one proposal for creating a multi-link communication with a mmWave link and non-mmWave link was proposed in U.S. Patent Publication No. 2024/0155715 which describes a multi-link operation for using a cross-link (non-mmWave link in 2.4/5/6 GHz and mmWave link in 60/45 GHz) or mmWave link for transmitting mmWave control/management information. In particular, the proposal describes a general sector level sweep procedure which uses a control frame exchange (e.g., NDPA) at a non-mmWave link to negotiate and initiate the SLS procedure where the AP MLD (or initiator) transmits a training PPDU to the non-AP MLD (or responder) over a mmWave link to sweep through various antenna weight vectors (AWVs) corresponding to different sectors with different start time options, where the non-AP MLD (or responder) sends feedback over the non-mmWave link.

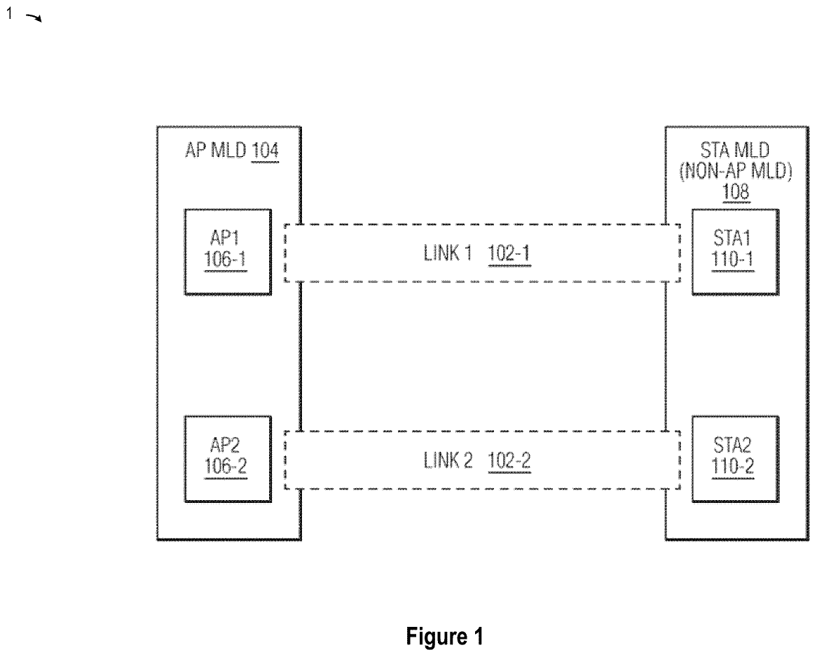

To provide an improved understanding of selected embodiments of the present disclosure, reference is now made to FIG. 1 which depicts a simplified block diagram of a multi-link communications system 1 that is used for wireless (e.g., WiFi) communications. As depicted, the multi-link communications system 1 includes one AP multi-link device (MLD) 104 and one non-AP STA MLD 108. The multi-link communications system 1 can be used in various applications, such as industrial applications, medical applications, computer applications, and/or consumer or enterprise applications. In some embodiments, the multi-link communications system 1 may be a wireless communications system, such as a wireless communications system compatible with an IEEE 802.11 protocol. For example, the multi-link communications system may be a wireless communications system compatible with an IEEE 802.11bq protocol. Although the depicted multi-link communications system 1 is shown with certain components and described with certain functionality herein, other embodiments of the multi-link communications system 1 may include fewer or more components to implement the same, less, or more functionality. For example, although the multi-link communications system 1 includes a single AP MLD 104 and a single STA MLD 108, in other embodiments, the multi-link communications system includes other multi-link devices, such as, multiple AP MLDs and multiple STA MLDs, multiple AP MLDs and a single STA MLD, a single AP MLD and multiple STA MLDs. In other embodiments, the multi-link communications system includes multiple STA MLDs and/or multiple AP MLDs. And while the multi-link communications system 1 is shown as being connected in a certain topology, the network topology of the multi-link communications system 1 is not limited to the depicted.

The depicted AP MLD 104 includes two radios, AP1 106-1 and AP2 106-2. In some embodiments, the AP MLD 104 is an AP multi-link logical device or an AP multi-link logical entity (MLLE). In selected embodiments, a common part of the AP MLD 104 implements upper layer Media Access Control (MAC) functionalities (e.g., beaconing, association establishment, reordering of frames, etc.) and a link-specific part of the AP MLD 104 (i.e., the APs 106-1, 106-2) implements lower layer MAC functionalities (e.g., backoff, frame transmission, frame reception, etc.). The APs 106-1, 106-2 may be implemented in hardware (e.g., circuits), software, firmware, or a combination thereof. The APs 106-1, 106-2 may be fully or partially implemented as an integrated circuit (IC) device. In some embodiments, the APs 106-1, 106-2 may be wireless APs compatible with at least one WLAN communications protocol (e.g., at least one IEEE 802.11 protocol). For example, the APs 106-1, 106-2 may be wireless APs compatible with an IEEE 802.11bq protocol.

In selected embodiments, an AP MLD 104 connects to a local network (e.g., a LAN) and/or to a backbone network (e.g., the Internet) through a wired connection and wirelessly connects to wireless STAs, for example, through one or more WLAN communications protocols, such as an IEEE 802.11 protocol. In some embodiments, an AP (e.g., AP1 106-1, and/or AP2 106-2) includes a plurality of antennas, at least one transceiver operably connected to the plurality of antennas, and at least one controller operably connected to the corresponding transceiver. In some embodiments, at least one transceiver includes a physical layer (PHY) device. The at least one controller may be configured to control the at least one transceiver to process received packets through the plurality of antennas. In some embodiments, the at least one controller may be implemented within a processor, such as a microcontroller, a host processor, a host, a digital signal processor (DSP), or a central processing unit (CPU), which can be integrated in a corresponding transceiver. In some embodiments, each of the APs 106-1, 106-2 may operate in different frequency bands. For example, at least one of the APs 106-1, 106-2 of the AP MLD 104 may operate in an Extremely High Frequency (EHF) band or the “millimeter wave (mmWave)” frequency band. In selected embodiments, the mmWave frequency band is a frequency band between 20 Gigahertz (GHz) and 300 GHz. For example, the mmWave is a frequency band above 45 GHz, (e.g., a 60 GHz frequency band). In addition, at least one of the APs 106-1, 106-2 of the AP MLD 104 may operate at a non-mmWave frequency band, such as a 5 Gigahertz (GHz) band (e.g., in a 320 MHz (one million hertz) Basic Service Set (BSS) operating channel or other suitable BSS operating channel). Although the AP MLD 104 is shown as including two APs, other embodiments of the AP MLD 104 may include more than two APs.

In similar fashion, the depicted non-AP STA multi-link device 108 includes two radios which are implemented as non-AP STAs, STA1 110-1 and STA2 110-2. The STAs 110-1, 110-2 may be implemented in hardware (e.g., circuits), software, firmware, or a combination thereof. One or more of the STAs 110-1, 110-2 may be fully or partially implemented as an IC device. In some embodiments, the non-AP STAs 110-1, 110-2 are part of the STA MLD 108, such that the STA MLD may be a communications device that wirelessly connects to a wireless AP MLD. For example, the STA MLD 108 may be implemented in a laptop, a desktop personal computer (PC), a mobile phone, or other communications device that supports at least one WLAN communications protocol. In some embodiments, the non-AP STA MLD 108 is a communications device compatible with at least one IEEE 802.11 protocol (e.g., an IEEE 802.11bq protocol). In some embodiments, the STA MLD 108 implements a common MAC data service interface and the non-AP STAs 110-1, 110-2 implement a lower layer MAC data service interface.

In some embodiments, the AP MLD 104 and/or the STA MLD 108 may identify which communication links support multi-link operation during a multi-link operation setup phase and/or exchanges information regarding multi-link capabilities during the multi-link operation setup phase. In some embodiments, each of the non-AP STAs 110-1, 110-2 of the STA MLD 108 may operate in a different frequency band. For example, the non-AP STA 110-1 may operate in the 5 GHz frequency band and the non-AP STA 110-2 may operate in the 60 GHz frequency band. In some embodiments, each STA includes a plurality of antennas, at least one transceiver operably connected to the plurality of antennas, and at least one controller connected to the corresponding transceiver. In some embodiments, at least one transceiver includes a PHY device. The at least one controller may be configured to control the at least one transceiver to process received packets through the plurality of antennas. In some embodiments, the at least one controller may be implemented within a processor, such as a microcontroller, a host processor, a host, a DSP, or a CPU, which can be integrated in a corresponding transceiver. In selected embodiments, the STA MLD 108 has one MAC data service interface. In other selected embodiments, the STA MLD 108 implements a common MAC data service interface and the non-AP STAs 110-1, 110-2 implement a lower layer MAC data service interface. In selected embodiments, the AP MLD 104 and/or the STA MLD(s) 108 identify which communications links support the multi-link operation during a multi-link operation setup phase and/or exchanges information regarding multi-link capabilities during the multi-link operation setup phase. Each of the STAs 110-1, 110-2 of the STA MLD 108 may operate in a different frequency band. For example, at least one of the STAs 110-1, 110-2 operates in the mmWave frequency band. In some embodiments, the mmWave frequency band is a frequency band between 20 GHz and 300 GHz. For example, the mmWave frequency band is a frequency band above 45 GHz, e.g., a 60 GHz frequency band. In addition, at least one of the APs 106-1, 106-2 of the AP MLD 104 may operate at a non-mmWave frequency band, such as 5 GHz band (e.g., in a 320 MHz (one million hertz) BSS operating channel or other suitable BSS operating channel). Although the STA MLD 108 is shown as including two non-AP STAs, additional non-AP STAs may be included.

In operation, the STA MLD 108 communicates with the AP MLD 104 via two communication links, link 1 102-1 and link 2 102-2. For example, each of the non-AP STAs 110-1, 110-2 communicates with an AP 106-1, 106-2 via corresponding communication links 102-1, 102-2. In an embodiment, a communication link (e.g., link 1 102-1 or link 2 102-2) may include a first operating channel established by an AP (e.g., AP1 106-1 or AP2 106-2) that is used to transmit frames (e.g., Physical Layer Convergence Protocol (PLCP) Protocol Data Units (PPDUs), Beacon frames, management frames, etc.) between a first wireless device (e.g., an AP, an AP MLD, an STA, or an STA MLD) and a second wireless device (e.g., an AP, an AP MLD, an STA, or an STA MLD). Although the STA MLD 108 is shown as including two non-AP STAs 110-1, 110-2, other embodiments of the STA MLD 108 may include one non-AP STA or more than two non-AP STAs. In addition, although the AP MLD 104 communicates (e.g., wirelessly communicates) with the STA MLD 108 via the communications links 102-1, 102-2, in other embodiments, the AP MLD 104 may communicate (e.g., wirelessly communicate) with the STA MLD 108 via more than two communication links. As disclosed herein, the communications links 102-1, 102-2 between the AP MLD 104 and the STA MLD 108 include at least one mmWave link and one non-mmWave link. For example, the communications links 102-1, 102-2 may include an mmWave link (e.g., a 45/60 GHz link) between an AP 106-1 of the AP MLD 104 and an STA 110-1 of the STA MLD 108 operating in a mmWave frequency band (e.g., a 45/60 GHz frequency band) and may also include a non-mmWave link (e.g., 2.4 GHz, 5 GHz, or 6 GHz links) between another AP 106-2 of the AP MLD 104 and an STA 110-2 of the STA MLD 108 operating in non-mmWave frequency bands (e.g., 2.4 GHz, 5 GHz, or 6 GHz frequency bands). The control and management of an mmWave link, for example, a 45 GHz/60 GHz link may be performed by having an initiator MLD (e.g., an AP MLD 104 or non-AP MLD (STA MLD) 108)) send management/control information in a non-mmWave link, for example, a 2.4 GHz, 5 GHz, or 6 GHz link. For example, the association of a non-AP MLD with an mmWave link can be done through a non-mmWave MHz link.

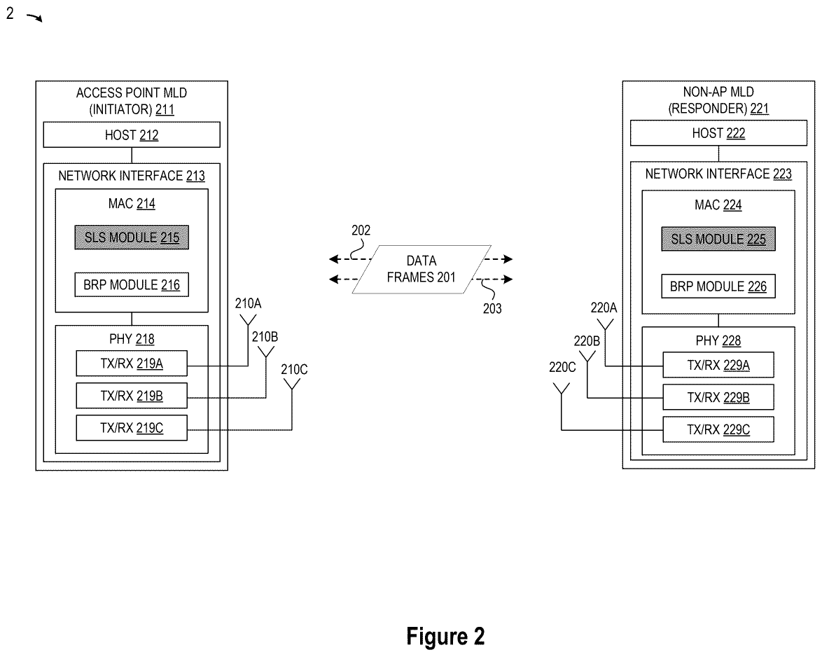

To provide an improved understanding of selected embodiments of the present disclosure, reference is now made to FIG. 2 is a simplified block diagram of a wireless communications system 2, such as a wireless local area network (WLAN), in which a transmitter access point (AP) MLD 211 and one or more wireless non-AP MLDs 221 use beamforming to transmit and receive data packets. As depicted, the AP MLD 211 includes a host processor 212 coupled to a network interface 213. In selected embodiments, the network interface 213 includes one or more integrated circuits (IC) devices configured to operate a local area network (LAN) protocol. To this end, the network interface 213 may include a medium access control (MAC) processor 214 and a physical layer (PHY) processor 218. In selected embodiments, the MAC processor 214 is implemented as an 802.11bq MAC processor 214, and the PHY processor 218 is implemented as an 802.11bq PHY processor 218. The PHY processor 218 includes a plurality of transceivers 219A-C which are coupled to a plurality of antennas 210A-C. Although three transceivers 219A-C and three antennas 210A-C are illustrated, the AP MLD 211 may use any suitable number of transceivers 219 and antennas 210 in other embodiments. In addition, the AP MLD 211 may have more antennas 210 than transceivers 219, in which case antenna switching techniques are used to switch the antennas 210 between the transceivers 219. In selected embodiments, the MAC processor 214 is implemented with one or more integrated circuit (IC) devices, and the PHY processor 218 is implemented on one or more additional IC devices. In other embodiments, at least a portion of the MAC processor 214 and at least a portion of the PHY processor 218 are implemented on a single IC device. In various embodiments, the MAC processor 214 and the PHY processor 218 are configured to operate according to at least a first communication protocol (e.g., 802.11bq). In other embodiments, the MAC processor 214 and the PHY processor 218 are also configured to operate according to one or more additional communication protocols (e.g., according to the IEEE 802.11bn Standard). Using the communication protocol(s), the AP MLD 211 is operative to create a wireless local area network (WLAN) in which one or more client stations (e.g., 221) may communicate with the AP MLD 211 and/or with other client stations (not shown) located within the WLAN. Although a single client station 221 is illustrated in FIG. 2, the WLAN may include any suitable number of client stations in various scenarios and embodiments.

As depicted, the wireless non-AP MLD 221 includes a host processor 222 coupled to a network interface 223. In selected embodiments, the network interface 223 includes one or more IC devices configured to operate as discussed below. For example, the depicted network interface 223 may include a MAC processor 224 and a PHY processor 228. In selected embodiments, the MAC processor 224 is implemented as an 802.11bq MAC processor 224, and the PHY processor 228 is implemented as an 802.11bq PHY processor 228. The PHY processor 228 includes a plurality of transceivers 229A-C coupled to a plurality of antennas 220A-C. Although three transceivers 229A-C and three antennas 220A-C are illustrated, the receiver STA 21 may include any suitable number of transceivers 229 and antennas 220. In addition, the non-AP MLD 221 may include more antennas than transceivers, in which case antenna array switching techniques are used. In selected embodiments, the MAC processor 224 is implemented on at least a first IC device, and the PHY processor 228 is implemented on at least a second IC device. In other embodiment, at least a portion of the MAC processor 224 and at least a portion of the PHY processor 228 are implemented on a single IC device.

In operation, the AP MLD 211 is configured to transmit or exchange data frames 201 with the non-AP MLD 221 over a mmWave link 202 by using beamforming with antenna arrays 210 to compensate for the high pathloss. To this end, each initiator STA device (e.g., AP MLD 211) includes an SLS module 215 which is configured to perform an initial sector level sweep (SLS) operation to find initial antenna weight vectors (AWV) or beamforming weights for analog beamforming to enable the AP MLD 211 and non-AP MLD 221 to communicate. In particular, the SLS module 215 configures the PHY processor 218 and transmit antennas 210 to perform a coarse search to find the best directional beam for communicating with the non-AP MLD 221 by sweeping through a set of predefined beams to find the one with the strongest signal. In selected embodiments, this is performed by transmitting a plurality of SLS training packets (or training PPDUs) to the responder device (e.g., non-AP MLD 221) with a different beamforming pattern applied when transmitting each SLS training packet.

Once a coarse beam is selected by the SLS module 215, a more detailed process begins to “refine” the beam. To this end, each initiator STA device (e.g., AP MLD 211) may include a beam refinement protocol (BRP) module 216 which is configured to further train the device receive and transmit antenna array(s) and improve its transmit (Tx) and receive (Rx) antenna configuration on top of SLS. In particular, the BRP module 216 configures the PHY processor 218 and transmit antennas 210 to perform a beam refinement search, such as by performing sub-beam sweeping or fine-tuning the phase and amplitude of the signals transmitted from each antenna element. In selected embodiments, this is performed by transmitting a plurality of BRP training packets (or training PPDUs) to the non-AP MLD 221 with a different beamforming pattern applied when transmitting each BRP training packet. When multiple Tx/Rx RF chains (each connecting to an antenna array) are enabled, the digital beamforming training could be further conducted once the analog beaming with BRP procedure is done and the analog AWVs are applied on both Tx/Rx RF chains.

In turn, the non-AP MLD 221 is configured to receive or exchange data frames 201 with the AP MLD 221 over a mmWave link 202 by using beamforming with antenna arrays 220 to compensate for the high pathloss. To this end, each responder STA device (e.g., non-AP MLD 221) includes an SLS module 225 and BRP module 226 which respectively perform the reception processing functions for the SLS operations, BRP operations, and more. In particular, the SLS module 225 is configured to measure SLS training PPDU signal quality values to determine a transmit beam ranking from the plurality of SLS training packets transmitted to the non-AP MLD 221. Similarly, the BRP module 226 is configured to measure BRP training PPDU signal quality values to determine a transmit beam ranking from the plurality of BRP training packets transmitted to the non-AP MLD 221.

In the context of the present disclosure, it will be understood by those skilled in the art that conventional DMG beamforming approaches are not widely adopted in the market due to the complexity and high cost. For example, existing approaches use standalone mmWave link sector level sweep (SLS) procedures that are usually limited by the transmit sector sweep (TXSS) only procedure and require a special control PHY design with better sensitivity to compensate the gap between transmit (Tx) beamforming gain only vs. the combined Tx/Rx (receive) BF gain. To address these and other shortcomings of the existing 802.11 capabilities, the SLS modules 215, 225 are configured with an improved SLS procedure at each STA device which uses an MLO process to establish the mmWave link by making use of the non-mmWave link packet exchange.

In particular and as described more fully hereinbelow, the SLS module 215 is configured to establish a mmWave link 202 by performing an MLO-assisted SLS procedure that is initiated with an announcement (or setup) frame exchange on a non-mmWave link 203 that occurs when the mmWave link 202 is yet to be established and/or when a beam/link failure at the mmWave link 202 is detected which requires the retraining of the Tx and/or Rx beam pair. Using the announcement frame exchange, the AP STA MLD 211 and non-AP MLD 221 can negotiate all the training parameters to be sent over the mmWave link 202, including the number of SLS training PPDU/Beams, the transmit sector sweep (TXSS) and/or receive sector sweep (RXSS) configurations, the directional or omni-directional Rx info (if this is an option), etc.

Based on the training parameters contained in the announcement frame exchange, the initiator (e.g., AP MLD 211) transmits the SLS training PPDU sequence in the mmWave link following the announcement frame exchange, after a delay time. In selected embodiments, the delay time could be a predefined IFS if the medium is already reserved or available by other medium access mechanism. Alternatively, the delay time could be a medium access time with backoff based on the medium availability status according to clear channel assessment (CCA) function. Alternatively, a proper medium access mechanism can be defined to use either the predefined IFS or a medium access time with backoff or both are allowable.

In order to improve the signal transmission range, the SLS module 215 is configured to generate the SLS training PPDU sequence based on the Tx/Rx beam reciprocity property and training PPDU sensitivity. For example, based on the SLS training PPDU sensitivity, the SLS training PPDU sequence generated by the SLS module 215 could have the option to use an omni-directional receiver or a directional receiver.

In selected embodiments where the non-AP MLD includes an omni-directional receiver, the SLS module 215 may require an SLS training PPDU sequence design with a sensitivity that is a minimum threshold (e.g., X dB) above the sensitivity of the lowest MCS for the data PPDU. In this case, the SLS training PPDU sequence with an omni-directional Rx will allow sufficient sensitivity for omni-directional receiver but still maintain the signal transmission range. In an example embodiment, this can occur if the data PPDU has higher bandwidth (BW) than that of the SLS training PPDU sequence such that extra power gain is obtained to achieve the better sensitivity, etc.

In other selected embodiments where the non-AP MLD includes a directional receiver, the SLS module 215 may specify an SLS training PPDU sequence design that reuses the same upclocked PPDU design from sub-7 GHz for both training PPDU and data PPDU, in which case the range can be maintained by using a directional receiver with Rx AWV sweep.

In selected embodiments of the present disclosure, the SLS module 215 is configured to apply each SLS training PPDU with one single Tx AWV/Beam.

In other embodiments of the present disclosure, the SLS module 215 is configured to specify an SLS training PPDU sequence by adding one or more additional training (TRN) fields at the end of each training PPDU for the receive beam training when the receiver uses an omni-directional beam for packet detection and the Tx/Rx beam is reciprocal. In such embodiments, the TRN fields can reuse the same/similar LTF sequence design as in the sub-7 GHz PPDU format.

In other embodiments of the present disclosure, the SLS module 215 is configured to configure the training PPDU as a one-stream transmission, and one Tx RF chain is enabled each time for SLS training.

As will be appreciated, the SLS module 225 at the responder (e.g., non-AP MLD 221) may be configured to detect the SLS training PPDU sequence and to measure the training PPDU receive quality to determine the quality of corresponding Tx beam used by the initiator (e.g., AP MLD 211). In such embodiments, the SLS module 225 may be configured to send a feedback message containing the Tx beam quality ranking via a non-mmWave link. In selected embodiments, the feedback message may be initiated by the responder in response to receiving the SLS training PPDU sequence. In other embodiments, the feedback message may be solicited by the transmitter transmitting a polling packet, such as a beamforming (BF) poll message or other suitable trigger frame.

As disclosed herein, the “initiator” of the MLO-assisted SLS procedure disclosed herein can be the AP MLD 211 and the “responder” can be the non-AP STA MLD 221. Alternatively, the “initiator” of the MLO-assisted SLS procedure disclosed herein can be the non-AP STA MLD 221 and the “responder” can be the AP MLD 211.

In selected embodiments, the transmit sector sweeps (TXSS) of the initiator and responder can be initiated once and executed sequentially. In other embodiments, the TXSS of the initiator can be initiated independently from the TXSS of the responder. In some selected embodiments, the AP MLD as an initiator can conduct TXSS simultaneously with one or multiple non-AP STA MLDs. As disclosed herein, the receiver sector sweeps (RXSS) of the initiator and responder may be done in SLS as well since the number of Rx AWVs can be communicated in the non-mmWave link. This approach for RXSS is different from the 802.11ad/ay standard (e.g., see IEEE P802.11-REVme/D4.0, August 2023) where only TXSS is conducted in SLS during beacon header interval (BHI) for initial link establishment.

As disclosed herein, there can be differences in the MLO-assisted SLS procedure implemented by the SLS modules 215, 225 at the initiator and responder, depending on whether it uses an omni-directional receiver or directional receiver for packet detection, which could include an RXSS that is different from conventional solutions. While the present disclosure is provided with reference to the initiator being an AP STA (MLD) that initiates the TXSS with an announcement frame (i.e., NDPA) and generates a training PPDU having an NDP format, it will be appreciated that the initiator can be a non-AP STA (MLD) which uses other options for initiating the TXSS. For example, the NDP announcement (NDPA) frame could be a modified version from sub-7 GHz to facilitate the mmWave link beam training needs. Of course, an announcement frame may have another name, especially if the training PPDU is not in the NDP format. For example, the 802.11ad/ay standard (IEEE P802.11-REVme/D4.0, August 2023) uses the sector sweep (SSW) frame, short sector sweep (SSSW) frame or DMG Beacon frame as the SLS training PPDUs. In addition, the announcement frame can be another format/name than NDPA (name based on sub-7 GHz beamforming sounding) to negotiate the training parameters. And while the present disclosure is provided with reference to the non-mmWave link being a 5 GHz band and the mmWave link being a 60 GHz band, it will be appreciated that other non-mmWave bands below 7 GHz can be used, and that other mmWave bands between 42 GHz and 71 GHz can be used.

### SLS Procedure with Omni-Directional Receivers

In selected embodiments of the present disclosure, there are disclosed various frame exchange sequences for an MLO-assisted SLS procedure which are initiated on a non-mmWave link to establish a mmWave link between initiator and responder devices which have omni-directional receivers that are used during training packet detection. As will be appreciated, omni-directional receivers operating without receiver beamforming gain can have limited transmission signal range unless there is a higher sensitivity training PPDU design than any data PPDU with optimal Tx/Rx beam pair applied such that the range will not be limited by the TXSS only training. To enhance the SLS training efficiency, the receiver may receive the preamble portion of each PPDU with an omni-directional beam, and then if there are any training (TRN) fields added at the end of each training PPDU, the receiver can switch AWVs in the TRN field to train the Rx AWVs of the receiver once the training PPDU is detected with the PHY preamble. As disclosed herein, the MLO-assisted SLS procedure can signal the RXSS with extra receive TRN field, such as by using an exchange of announcement frame packets, such as an NDPA/ACK exchange or other methods exchanged before transmitting the SLS training PPDU sequence. In selected embodiments, the acknowledgement (ACK) frame could be provided in a format/name as a response frame to negotiate the training parameters, instead of acknowledgement use only depends on the subsequent training sequence.

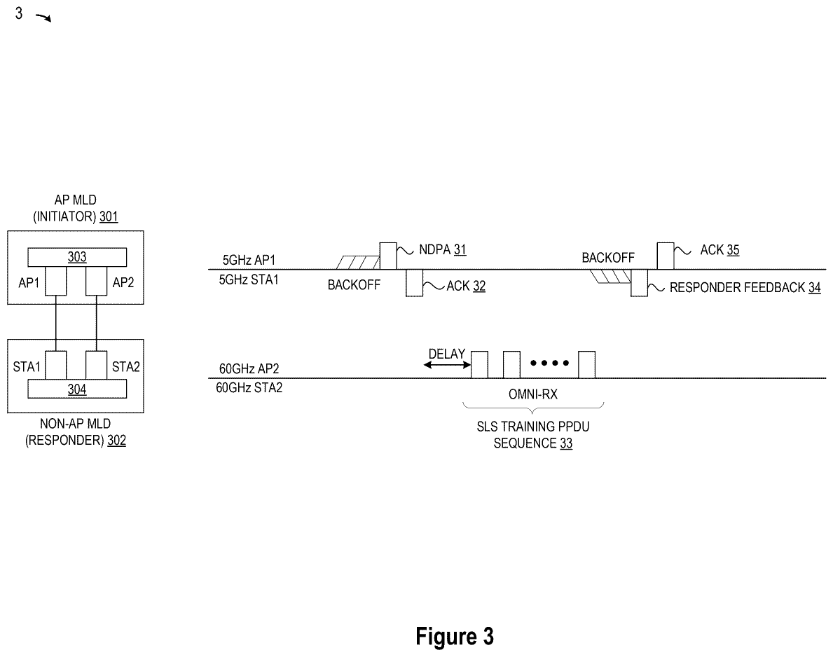

To provide additional details for an improved understanding of selected embodiments of the present disclosure, reference is now made to FIG. 3 which depicts a first case example of a frame exchange sequence for an MLO-assisted SLS procedure 3 which is initiated on a non-mmWave link to establish a mmWave link between an AP MLD 301 and a non-AP MLD 302 which have omni-directional receivers and which have TX/RX beam reciprocity, where a first responder feedback option is provided at the non-mmWave link after a negotiated time delay. In the depicted MLO-assisted SLS procedure 3, frames are exchanged between an AP MLD 301 (which includes a common MAC controller 303 and two wireless APs AP1, AP2) and a non-AP MLD 302 (which includes a common MAC controller 304 and two wireless STAs STA1, STA2). In selected embodiments, the common MAC controller 303 implements upper layer MAC functionalities (e.g., association establishment, etc.) of the AP MLD 301, and a link specific part of the AP MLD 301 (i.e., AP1, AP2) implements lower layer MAC functionalities (e.g., backoff, frame transmission, frame reception, etc.) of the AP MLD 301. In similar fashion, the common MAC controller 304 implements upper layer MAC functionalities (e.g., association establishment, etc.) of the non-AP MLD 302 and a link specific part of the non-AP MLD 302 (i.e., STA1, STA2) implements lower layer MAC functionalities (e.g., backoff, frame transmission, frame reception, etc.) of the non-AP MLD 302. The AP MLD 301 may be implemented in an embodiment with the AP MLD 211 depicted in FIG. 2, but may be implemented with any suitable controller design, such as a host processor and network interface connected to a MAC processor and PHY processor. Likewise, the non-AP MLD 302 may be implemented in an embodiment with the non-AP MLD 221 depicted in FIG. 2, but may be implemented with any suitable controller design, such as a host processor and network interface connected to a MAC processor and PHY processor.

In the example frame exchange sequence for an MLO-assisted SLS procedure 3, after an initial backoff period expires (i.e., backoff counter becomes zero), AP1 transmits an NDPA 31 to STA1 through the non-mmWave link (e.g., a 5 GHz band link) between AP1 and STA1, and STA1 acknowledges the NDPA 31 by transmitting an acknowledgement (ACK) 32. The initiator and the responder (e.g., AP2 and STA2, respectively) negotiate a delay time (DELAY) required between the end of frame exchange of the NDPA/ACK and the start of sounding in a mmWave link (e.g., a 60 GHz band link) between AP2 and STA2. The negotiated time and the end time of NDPA frame exchange decide when the sounding in the mmWave link starts. After the delay time, both AP2 and STA2 on the mmWave link are ready to do the sounding such that an SLS training PPDU sequence 33 is communicated or conducted from AP2 to STA2 through the mmWave link (e.g., a 60 GHz band link) between AP2 and STA2. As disclosed, the SLS training PPDU sequence 33 is sent as a sector sweep with a number of Nₜ training PPDU sequences, where Nₜ is a positive integer. After the SLS training PPDU sequence 33 is completed and a controlled backoff period expires (i.e., backoff counter becomes zero), STA1 transmits a responder feedback message 34 to AP1 through the non-mmWave link (e.g., a 5 GHz band link), and AP1 acknowledges the responder feedback message 34 by transmitting an ACK message 35.

In the depicted frame exchange sequence for an MLO-assisted SLS procedure 3, there is a mmWave link (e.g., a 45 GHz link or a 60 GHz link) between the AP2 and STA2 which operates in a mmWave frequency band (e.g., a 45 GHz or 60 GHz frequency band) and which is capable of mmWave communications. In addition, there is a non-mmWave link (e.g., a 2.4/5/6 GHz band link) between AP1 and STA1, which operates in a non-mmWave frequency band (e.g., a 2.4 GHz, 5 GHz, or 6 GHz frequency band) and which is capable of non-mmWave communications. Although the AP MLD 301 is shown with two APs, other embodiments of the AP MLD 301 may include fewer or more APs. In addition, although the non-AP MLD 302 is shown with two non-AP STAs, other embodiments of the non-AP MLD 302 may include fewer or more non-AP STAs.

In the depicted first case example of a frame exchange sequence for an MLO-assisted SLS procedure 3, the initiator 301 and responder 302 have Tx/Rx beam reciprocity which may be signaled via the Link Capability signal information which the MLDs exchange during the multi-link setup process to inform each other about their multi-link abilities. With Tx/Rx beam reciprocity, the best Tx AWV can be used as the Rx AWV for the initiator 301. And by including an extra Rx TRN field in each training PPDU to train the receive AWVs (RXSS), the best Rx AWV can be used as the Tx AWV for the responder 302, and the SLS is done after a valid responder feedback message 34 is received by initiator 301. In the depicted MLO-assisted SLS procedure 3, the responder 302 initiates sending the responder feedback message 34 at the non-mmWave (e.g., 5 GHz) link after a negotiated time or after it receives at least one training PPDU, and through medium access with backoff.

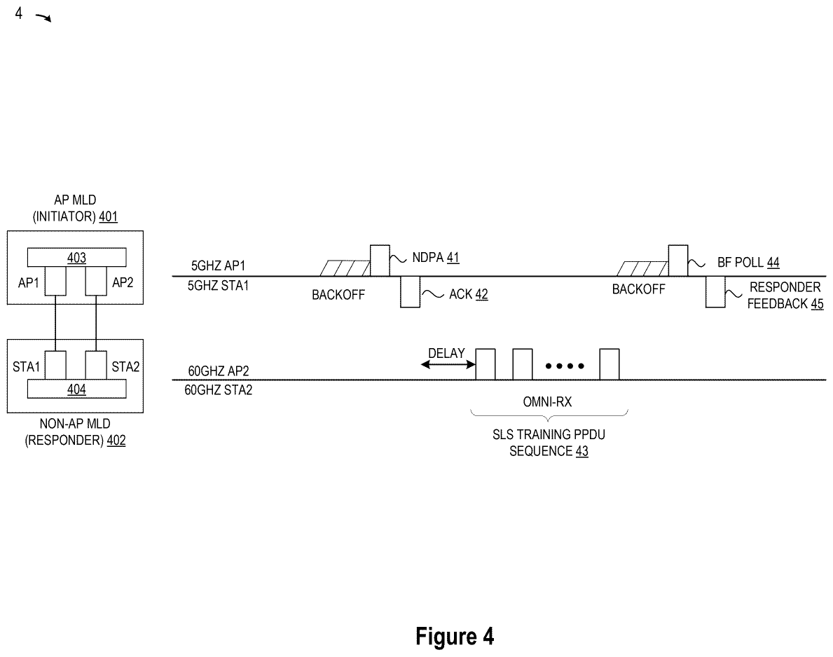

To provide additional details for an improved understanding of selected embodiments of the present disclosure, reference is now made to FIG. 4 which depicts an alternative first case example of a frame exchange sequence for an MLO-assisted SLS procedure 4 which is initiated on a non-mmWave link to establish a mmWave link between an AP MLD 401 and a non-AP MLD 402 which have omni-directional receivers and which have TX/RX beam reciprocity, where a second responder feedback option is provided at the non-mmWave link in response to a transmitter poll request message. In the depicted MLO-assisted SLS procedure 4, frames are exchanged between an AP MLD 401 (which includes a common MAC controller 403 and two wireless APs AP1, AP2) and a non-AP MLD 402 (which includes a common MAC controller 404 and two wireless STAs STA1, STA2). In selected embodiments, the common MAC controller 403 implements upper layer MAC functionalities of the AP MLD 401, and a link specific part of the AP MLD 401 (i.e., AP1, AP2) implements lower layer MAC functionalities of the AP MLD 401. In similar fashion, the common MAC controller 404 implements upper layer MAC functionalities of the non-AP MLD 402, and a link specific part of the non-AP MLD 402 (i.e., STA1, STA2) implements lower layer MAC functionalities of the non-AP MLD 402. As will be appreciated, the AP MLD 401 and non-AP MLD 402 may be implemented with any suitable controller design, such as a host processor and network interface connected to a MAC processor and PHY processor.

In the example frame exchange sequence for an MLO-assisted SLS procedure 4, after an initial backoff period expires (i.e., backoff counter becomes zero), AP1 transmits an NDPA 41 to STA1 through the non-mmWave link (e.g., a 5 GHz band link) between AP1 and STA1, and STA1 acknowledges the NDPA 41 by transmitting an ACK message 42. The initiator and the responder (e.g., AP2 and STA2, respectively) negotiate a delay time (DELAY) required between the end of frame exchange of the NDPA/ACK and the start of sounding in a mmWave link (e.g., a 60 GHz band link) between AP2 and STA2. The negotiated time and the end time of NDPA frame exchange decide when the sounding in the mmWave link starts. After the delay time, both AP2 and STA2 on the mmWave link are ready to do the sounding such that an SLS training PPDU sequence 43 is communicated or conducted through the mmWave link (e.g., a 60 GHz band link) between AP2 and STA2. As disclosed, the SLS training PPDU sequence 43 is sent as a sector sweep with a number of Nₜ training sequences, where Nₜ is a positive integer. After the SLS training PPDU sequence 43 is completed and a controlled backoff period expires (i.e., backoff counter becomes zero), the initiator (AP1) solicits feedback from the responder (STA1) by transmitting a polling packet 44 (e.g., a beamforming (BF) poll message or other suitable trigger frame) to STA1 through the non-mmWave link (e.g., a 5 GHz band link), and STA1 responds to the polling packet 44 by sending the responder feedback message 45. In the disclosed second responder feedback option, the initiator can send the polling packet 44 in a new TXOP with backoff because the medium of non-mmWave link may be used by non-AP MLD or others if the previous TXOP with NDPA is not reserved. Alternatively, the initiator can send the polling packet 44 in the same TXOP w/o backoff if the TXOP is reserved for the SLS training. As seen from the foregoing, there is no requirement for negotiating the time to send the responder feedback message when the initiator sends the polling packet 44 to the responder.

In the depicted frame exchange sequence for an MLO-assisted SLS procedure 4, there is a mmWave link (e.g., 60 GHz link) between the AP2 and STA2 which operates in a mmWave frequency band (e.g., a 45 GHz or 60 GHz frequency band) and which is capable of mmWave communications. In addition, there is a non-mmWave link (e.g., a 5 GHz band link) between AP1 and STA1, which operates in a non-mmWave frequency band (e.g., 5 GHz frequency band) and which is capable of non-mmWave communications. Although the AP MLD 401 is shown with two APs, other embodiments of the AP MLD 401 may include fewer or more APs. In addition, although the non-AP MLD 402 is shown with two non-AP STAs, other embodiments of the non-AP MLD 402 may include fewer or more non-AP STAs.

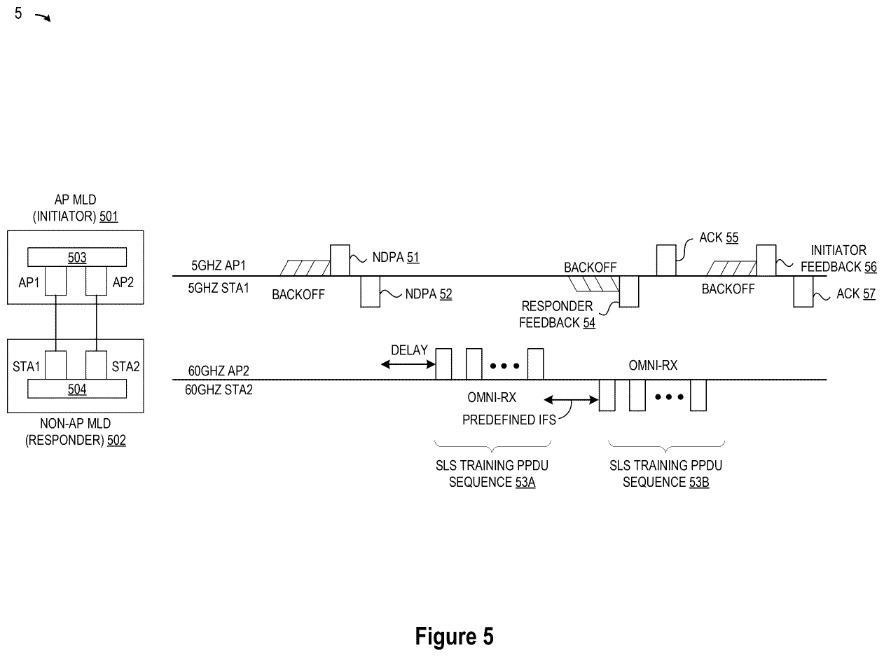

To provide additional details for an improved understanding of selected embodiments of the present disclosure, reference is now made to FIG. 5 which depicts a second case example of a frame exchange sequence for an MLO-assisted SLS procedure 5 which is initiated on a non-mmWave link to establish a mmWave link between an initiator (e.g., AP MLD 501) and responder (e.g., non-AP MLD 502) which have omni-directional receivers and which do not have TX/RX beam reciprocity, where both the initiator and responder separately send feedback at the non-mmWave link first responder feedback option is provided at the non-mmWave link after a negotiated time delay. In the depicted MLO-assisted SLS procedure 5, frames are exchanged between an AP MLD 501 (which includes a common MAC controller 503 and two wireless APs AP1, AP2) and a non-AP MLD 502 (which includes a common MAC controller 504 and two wireless STAs STA1, STA2). In selected embodiments, the common MAC controller 503 implements upper layer MAC functionalities of the AP MLD 501, and a link specific part of the AP MLD 501 (i.e., AP1, AP2) implements lower layer MAC functionalities of the AP MLD 501. In similar fashion, the common MAC controller 504 implements upper layer MAC functionalities of the non-AP MLD 502, and a link specific part of the non-AP MLD 502 (i.e., STA1, STA2) implements lower layer MAC functionalities of the non-AP MLD 502. As will be appreciated, the AP MLD 501 and non-AP MLD 502 may be implemented with any suitable controller design, such as a host processor and network interface connected to a MAC processor and PHY processor.

In the example frame exchange sequence for an MLO-assisted SLS procedure 5 where the initiator (AP MLD 501) and responder (non-AP MLD 502) do not have the Tx/Rx beam reciprocity, the responder's TXSS (with initiator RXSS) in the SLS training PPDU sequence 53B will follow after the initiator's SLS training PPDU sequence 53A TXSS (with responder RXSS), but the RXSS (via the extra receive TRN fields) is not necessarily required as the range is anyway determined by the omni-directional beam for packet detection and responder TXSS will be followed after the initiator TXSS. In particular, the example frame exchange sequence for the MLO-assisted SLS procedure 5 starts after an initial backoff period expires (i.e., backoff counter becomes zero) when AP1 transmits an NDPA 51 to announce the initiator TXSS 53A to STA1 through the non-mmWave link (e.g., a 5 GHz band link) between AP1 and STA1. In response, STA1 sends the NDPA 52 to announce the responder TXSS 53B will occur a predefined IFS after the initiator TXSS 53A. Next, the initiator and the responder (e.g., AP2 and STA2, respectively) negotiate a delay time (DELAY) required between the end of the NDPA frame exchange 51, 52 and the start of sounding in a mmWave link (e.g., a 60 GHz band link) between AP2 and STA2. The negotiated time and the end time of the NDPA frame exchange 51, 52 decide when the sounding in the mmWave link starts. After the delay time, both AP2 and STA2 on the mmWave link are ready to sequentially perform training through the mmWave link (e.g., a 60 GHz band link) with the initiator TXSS 53A being followed after a predefined delay by the responder TXSS 53B by transmitting the SLS training PPDU sequence 53A between AP2 and STA2, and then transmitting the SLS training PPDU sequence 53B between STA2 and AP2. In selected embodiments, the predefined delay for starting the responder TXSS start time can be calculated from the beam/AWV index from the initiator training PPDU with a predefined IFS, in which case the SLS training PPDU sequence 53B will not start if no SLS training PPDU sequence 53A is received during the initiator TXSS. In other embodiments (not shown), the initiator TXSS and the responder TXSS can be independently initiated within their own TXOP. As disclosed, each of the SLS training PPDU sequences 53A, 53B is sent as a sector sweep with a number of N_{t,i} or N_{t,r} training sequences, where N_{t,i} and N_{t,r} are positive integers and negotiated in the announcement frame exchange. After the SLS training PPDU sequence 53A with the initiator TXSS is completed and a negotiated time period expires (i.e., backoff counter becomes zero), the responder (STA1) transmits a responder feedback message 54 to AP1 through the non-mmWave link (e.g., a 5 GHz band link), and AP1 acknowledges the responder feedback message 54 by transmitting an ACK message 55. In similar fashion, after the SLS training PPDU sequence 53B with the responder TXSS is completed and a negotiated time period expires (i.e., backoff counter becomes zero), the initiator (AP1) transmits an initiator feedback message 56 to STA1 through the non-mmWave link (e.g., a 5 GHz band link), and STA1 acknowledges the initiator feedback message 56 by transmitting an ACK message 57. In the first responder feedback option, both the responder (502) and initiator (501) can send the feedback to the other side through channel access at the non-mmWave link after a negotiated time for the corresponding TXSS.

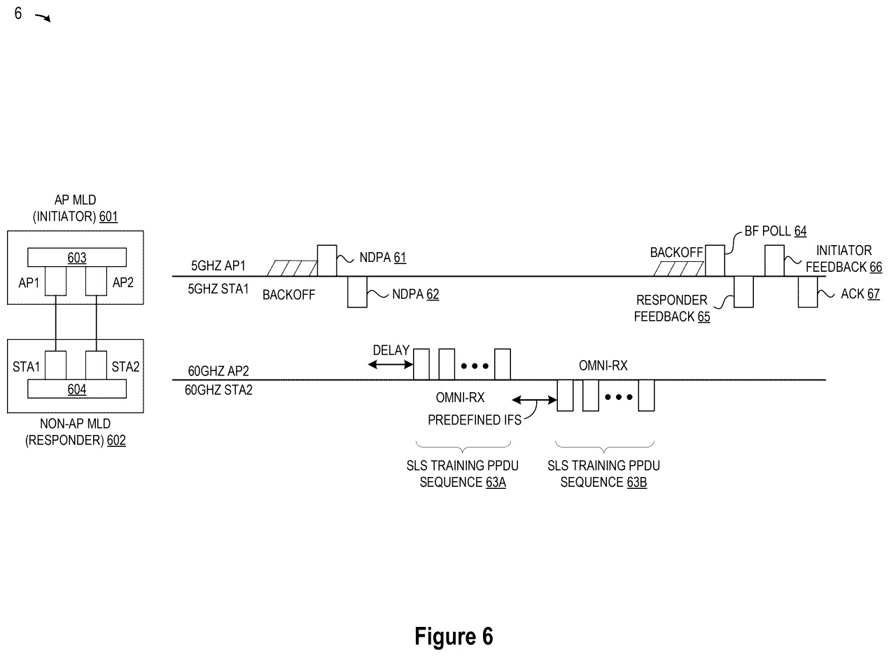

To provide additional details for an improved understanding of selected embodiments of the present disclosure, reference is now made to FIG. 6 which depicts an alternative second case example of a frame exchange sequence for an MLO-assisted SLS procedure 6 which is initiated on a non-mmWave link to establish a mmWave link between an AP MLD 601 and a non-AP MLD 602 which have omni-directional receivers and which do not have TX/RX beam reciprocity, where the initiator and responder use a second feedback option to sequentially provide feedback messages 65, 66 at the non-mmWave link in response to an initiator poll request message 64. In the depicted MLO-assisted SLS procedure 6, frames are exchanged between an AP MLD 601 (which includes a common MAC controller 603 and two wireless APs AP1, AP2) and a non-AP MLD 602 (which includes a common MAC controller 604 and two wireless STAs STA1, STA2). In selected embodiments, the common MAC controller 603 implements upper layer MAC functionalities of the AP MLD 601, and a link specific part of the AP MLD 601 (i.e., AP1, AP2) implements lower layer MAC functionalities of the AP MLD 601. In similar fashion, the common MAC controller 604 implements upper layer MAC functionalities of the non-AP MLD 602, and a link specific part of the non-AP MLD 602 (i.e., STA1, STA2) implements lower layer MAC functionalities of the non-AP MLD 602. As will be appreciated, the AP MLD 601 and non-AP MLD 602 may be implemented with any suitable controller design, such as a host processor and network interface connected to a MAC processor and PHY processor.

In the example frame exchange sequence for an MLO-assisted SLS procedure 6 where the initiator (AP MLD 601) and responder (non-AP MLD 602) do not have the Tx/Rx beam reciprocity, the responder's TXSS (with initiator RXSS) in the SLS training PPDU sequence 63B will follow after the initiator's SLS training PPDU sequence 63A TXSS (with responder RXSS), but the RXSS (via the extra receive TRN fields) is not necessarily required as the range is anyway determined by the omni-directional beam for packet detection and responder TXSS will be followed after the initiator TXSS. In particular, the example frame exchange sequence for the MLO-assisted SLS procedure 6 starts after an initial backoff period expires when AP1 transmits an NDPA 61 to announce the initiator TXXS 63A to STA1 through the non-mmWave link (e.g., a 5 GHz band link) between AP1 and STA1. In addition, STA1 sends the NDPA 62 to announce the responder TXSS 63B will occur a predefined IFS after the initiator TXSS 63A. After negotiating a delay time (DELAY) required after the end of the NDPA frame exchange 61, 62, the initiator and responder (e.g., AP2 and STA2, respectively) sequentially perform sounding through the mmWave link (e.g., a 60 GHz band link), with initiator AP2 transmitting the SLS training PPDU sequence 63A with the initiator TXSS to STA2, being followed after a predefined IFS delay by the responder STA2 transmitting the SLS training PPDU sequence 63B with the responder TXXS to AP2. The negotiated delay time and the end time of the NDPA frame exchange 61, 62 decide when the sounding in the mmWave link starts by sequentially transmitting the SLS training PPDU sequence 63A between the initiator and responder, followed after a predefined IFS delay by the transmitting the SLS training PPDU sequence 63B between the responder and initiator, where the predefined IFS delay for starting the transmission of the SLS training PPDU sequence 63B can be calculated from the beam/AWV index from the initiator training PPDU with a predefined IFS, in which case the SLS training PPDU sequence 63B will not start if no SLS training PPDU sequence 63A is received during the initiator TXSS. Alternatively, the initiator TXSS and the responder TXSS can be independently initiated within their own TXOP. As disclosed, each of the SLS training PPDU sequences 63A, 63B is sent as a sector sweep with a number of N_{t,i} or N_{t,r} training sequences, where N_{t,i} and N_{t,r} are positive integers and negotiated in the announcement frame exchange. After the SLS training PPDU sequence 63B is completed and a controlled backoff period expires (i.e., backoff counter becomes zero), the initiator and responder use a second feedback option to sequentially provide feedback messages 65, 66 at the non-mmWave link in response to an initiator poll request message 64. In particular, the initiator (AP1) solicits feedback from the responder (STA1) by transmitting a polling packet 64 (e.g., a beamforming (BF) poll message or other suitable trigger frame) to STA1 through the non-mmWave link (e.g., a 5 GHz band link). In response to the polling packet 64, STA1 sends the responder feedback message 65, and then AP1 sends the initiator feedback message 66. In response to receiving the initiator feedback message 66, STA1 transmits an ACK message 67.

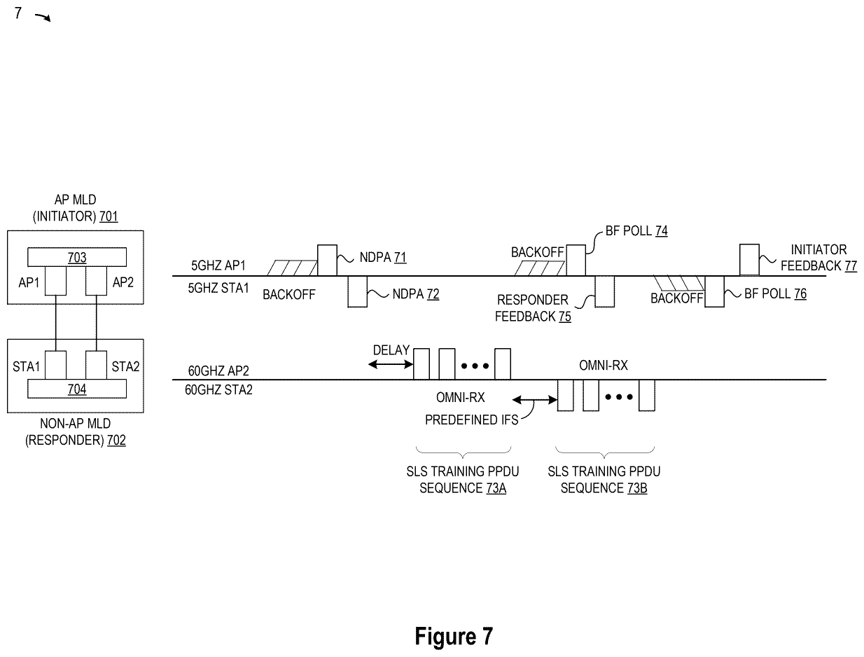

To provide additional details for an improved understanding of selected embodiments of the present disclosure, reference is now made to FIG. 7 which depicts an alternative third case example of a frame exchange sequence for an MLO-assisted SLS procedure 7 which is initiated on a non-mmWave link to establish a mmWave link between an initiator (AP MLD 701) and responder (non-AP MLD 702) which have omni-directional receivers and which do not have TX/RX beam reciprocity, where the initiator and responder use a third feedback option in which each training PPDU transmitter solicits a feedback message 75, 77 using a corresponding polling packet 74, 76 that is separately sent at the non-mmWave link after the corresponding TXSS is done. In the depicted MLO-assisted SLS procedure 7, frames are exchanged between an AP MLD 701 (which includes a common MAC controller 703 and two wireless APs AP1, AP2) and a non-AP MLD 702 (which includes a common MAC controller 704 and two wireless STAs STA1, STA2). In selected embodiments, the common MAC controller 703 implements upper layer MAC functionalities of the AP MLD 701, and a link specific part of the AP MLD 701 (i.e., AP1, AP2) implements lower layer MAC functionalities of the AP MLD 701. In similar fashion, the common MAC controller 704 implements upper layer MAC functionalities of the non-AP MLD 702, and a link specific part of the non-AP MLD 702 (i.e., STA1, STA2) implements lower layer MAC functionalities of the non-AP MLD 702. As will be appreciated, the AP MLD 701 and non-AP MLD 702 may be implemented with any suitable controller design, such as a host processor and network interface connected to a MAC processor and PHY processor.

In the example frame exchange sequence for an MLO-assisted SLS procedure 7 where the initiator (AP MLD 701) and responder (non-AP MLD 702) do not have the Tx/Rx beam reciprocity, the responder's TXSS (with initiator RXSS) in the SLS training PPDU sequence 73B will follow after the initiator's SLS training PPDU sequence 73A TXSS (with responder RXSS), but the RXSS (via the extra receive TRN fields) is not necessarily required as the range is anyway determined by the omni-directional beam for packet detection and responder TXSS will be followed after the initiator TXSS. In particular, the example frame exchange sequence for the MLO-assisted SLS procedure 7 starts after an initial backoff period expires when AP1 transmits an NDPA 71 to announce the initiator TXXS 73A to STA1 through the non-mmWave link (e.g., a 5 GHz band link) between AP1 and STA1. In addition, STA1 sends the NDPA 72 to announce the responder TXSS 73B will occur immediately after the initiator TXXS 73A. After negotiating a delay time (DELAY) required after the end of the NDPA frame exchange 71, 72, the initiator and responder (e.g., AP2 and STA2, respectively) sequentially perform training through the mmWave link (e.g., a 60 GHz band link), with initiator AP2 transmitting the SLS training PPDU sequence 73A with the initiator TXXS to STA2, being followed after a predefined IFS delay by the responder STA2 transmitting the SLS training PPDU sequence 73B with the responder TXSS to AP2. The negotiated delay time and the end time of the NDPA frame exchange 71, 72 decide when the sounding in the mmWave link starts by sequentially transmitting the SLS training PPDU sequence 73A between the initiator and responder, followed after a predefined IFS delay by the transmitting the SLS training PPDU sequence 73B between the responder and initiator, where the predefined IFS delay for starting the transmission of the SLS training PPDU sequence 73B can be calculated from the beam/AWV index from the initiator training PPDU with a predefined IFS, in which case the SLS training PPDU sequence 73B will not start if no SLS training PPDU sequence 73A is received during the initiator TXSS. Alternatively, the initiator TXSS and the responder TXSS can be independently initiated within their own TXOP. As disclosed, each of the SLS training PPDU sequences 73A, 73B is sent as a sector sweep with a number of N_{t,i} or N_{t,r} training sequences, where N_{t,i} and N_{t,r} are positive integers and negotiated by the announcement frame exchange. After each SLS training PPDU sequence 73A, 73B is completed, the initiator and responder use a third feedback option in which each training PPDU transmitter solicits a feedback message 75, 77 using a corresponding polling packet 74, 76 that is separately sent at the non-mmWave link after the corresponding TXSS is done. In particular, after the SLS training PPDU sequence 73A is completed and a controlled backoff period expires (i.e., backoff counter becomes zero), the initiator (AP1) solicits feedback from the responder (STA1) by transmitting a polling packet 74 (e.g., a beamforming (BF) poll message or other suitable trigger frame) to STA1 through the non-mmWave link (e.g., a 5 GHz band link). In response to the polling packet 74, STA1 sends the responder feedback message 75 on the non-mmWave link. And after the SLS training PPDU sequence 73B is completed and a controlled backoff period expires (i.e., backoff counter becomes zero), the responder (STA1) solicits feedback from the initiator (AP1) by transmitting a polling packet 76 (e.g., a BF poll message or other suitable trigger frame) to AP1 through the non-mmWave link (e.g., a 5 GHz band link). In response to the polling packet 76, AP1 sends the initiator feedback message 77 on the non-mmWave link.

### SLS Procedure with Directional Receivers

In selected embodiments of the present disclosure, there are disclosed various frame exchange sequences for an MLO-assisted SLS procedure which are initiated on a non-mmWave link to establish a mmWave link between initiator and responder devices which have directional receivers that are used during training packet detection. As will be appreciated, omni-directional receivers operating without receiver beamforming gain can have limited transmission signal range. To enhance the detection of SLS training PPDU sequences, the SLS procedure may use directional receivers for packet detection. In such embodiments, the transmitter does TXSS and the receiver uses one directional Rx beam for packet detection during each TXSS round (including announcement frame exchange, a training PPDU sequence sweeping through the Tx beams, and feedback if it is polled by the transmitter) initiated by the announcement frame exchange. The announcement frame may indicate the directional receive beam index and the receiver can choose to set which receiver AWV to use for each TXSS round right after it acknowledges the announcement frame. The transmitter sets the same transmit AWVs between each TXSS round. In such embodiments, the total number of N receive AWVs is negotiated before the training PPDU transmission at the non-mmWave link. The initiator can initiate M≤N rounds of TXSS until the responder detects at least one of the training PPDUs during that round of training. The training PPDU transmitter could choose to stop at the end of that TXSS round, as the beam can be refined further with better efficiency with the link established. Alternatively, training PPDU transmitter could choose to continue to finish the total N rounds based on the feedback. The transmitter's decision to stop or continue after M rounds is to make sure the training PPDU with this Tx/Rx AWV pair can be detected in mmWave link in later beam training phases. The criteria could be related to the training PPDU detection sensitivity difference between SLS and these later phases or other considerations.

An advantage of performing an SLS procedure with directional receivers is that there is no requirement for including extra TRN fields in the SLS training PPDUs for RXSS since the receiver already sweeps through different receive AWVs.

In cases where the receiver does not know when each TXSS round is finished (e.g., if the receiver cannot receive any training PPDUs and the training delay in the mmWave link is unpredictable), the transmitter can either use a polling packet (e.g., BF poll or trigger frame) to trigger the feedback or restart a new round of TXSS directly with announcement frame exchange. If the receiver cannot detect any training PPDUs, the feedback packet could be QoS Null data or same feedback format which includes an indication that no packet is detected.

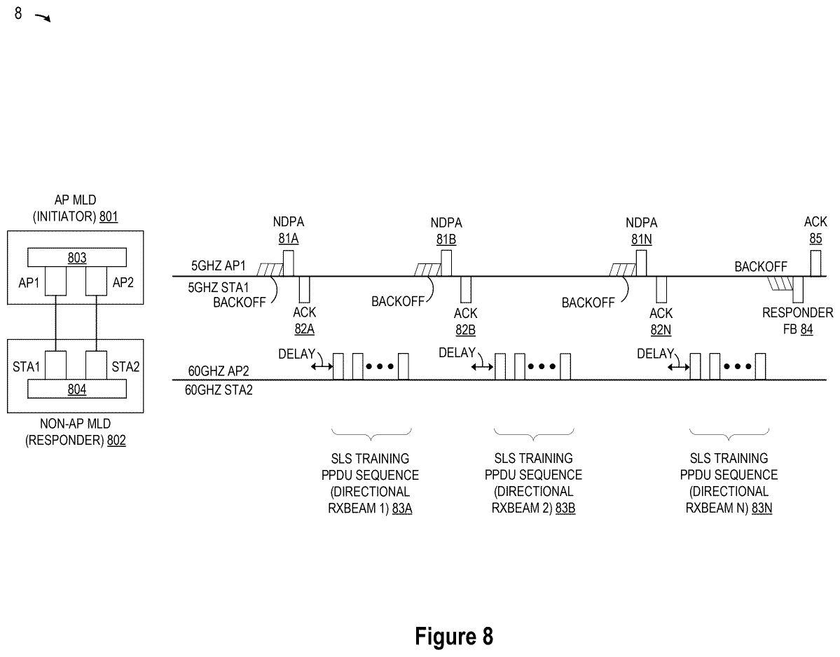

To provide additional details for an improved understanding of selected embodiments of the present disclosure, reference is now made to FIG. 8 which depicts a first case example of a frame exchange sequence for an MLO-assisted SLS procedure 8 which is initiated on a non-mmWave link to establish a mmWave link between an initiator (AP MLD 801) and a responder (non-AP MLD 802) which have directional receivers and which have TX/RX beam reciprocity, where a first responder feedback option is provided at the non-mmWave link at a negotiated time after the Nth announcement frame. In this scenario where the initiator and responder have the Tx/Rx beam reciprocity, the best Rx AWV for the initiator will also be the Tx AWV of responder in the reverse link, and the best Tx AWV of the initiator will be the Rx AWV for the responder.

In the depicted MLO-assisted SLS procedure 8, frames are exchanged between an AP MLD 801 (which includes a common MAC controller 803 and two wireless APs AP1, AP2) and a non-AP MLD 802 (which includes a common MAC controller 804 and two wireless STAs STA1, STA2). In selected embodiments, the common MAC controller 803 implements upper layer MAC functionalities of the AP MLD 801, and a link specific part of the AP MLD 801 (i.e., AP1, AP2) implements lower layer MAC functionalities of the AP MLD 801. In similar fashion, the common MAC controller 804 implements upper layer MAC functionalities of the non-AP MLD 802, and a link specific part of the non-AP MLD 802 (i.e., STA1, STA2) implements lower layer MAC functionalities of the non-AP MLD 802. As will be appreciated, the AP MLD 801 and non-AP MLD 802 may be implemented with any suitable controller design, such as a host processor and network interface connected to a MAC processor and PHY processor.

In the example frame exchange sequence for an MLO-assisted SLS procedure 8 where the initiator (AP MLD 801) and responder (non-AP MLD 802) have Tx/Rx beam reciprocity, the initiator (AP1) waits for an initial backoff period to expire (i.e., backoff counter becomes zero) before transmitting a first NDPA 81A to STA1 through the non-mmWave link (e.g., a 5 GHz band link) between AP1 and STA1, and STA1 acknowledges the first NDPA 81A by transmitting a first acknowledgement (ACK) 82A. The initiator and the responder (e.g., AP2 and STA2, respectively) negotiate a delay time (DELAY) required between the end of first NDPA/ACK frame exchange 81A, 82A and the start of a first training PPDU sequence in a mmWave link (e.g., a 60 GHz band link) between AP2 and STA2. The negotiated time and the end time of the first NDPA/ACK frame exchange 81A, 82A decide when the first training PPDU in the mmWave link starts. After the delay time, both AP2 and STA2 on the mmWave link are ready to do the first training PPDU sequence such that a first SLS training PPDU sequence 83A is communicated or conducted from AP2 to STA2 with a first directional receive beam (DIRECTIONAL RXBEAM 1) through the mmWave link (e.g., a 60 GHz band link). As disclosed, the initiator sends the first SLS training PPDU sequence 83A with a number of Nₜ training PPDUs, where Nₜ is a positive integer, and is received at the responder with the first directional receive beam (DIRECTIONAL RXBEAM 1). After the first SLS training PPDU sequence 83A is completed and a controlled backoff period expires (i.e., backoff counter becomes zero), the initiator (AP1) transmits a second NDPA 81B to STA1 through the non-mmWave link, the STA1 acknowledges the second NDPA 81B by transmitting a second ACK 82B, and then after a negotiated delay time (DELAY), the initiator (AP2) sends a second SLS training PPDU sequence 83B from AP2 with a second directional receive beam (DIRECTIONAL RXBEAM 2) at STA2 through the mmWave link. This process is iteratively repeated until the initiator (AP1) transmits the Nth NDPA 81N to STA1 through the non-mmWave link, the STA1 acknowledges the Nth NDPA 81N by transmitting the Nth ACK 82N, and then after a negotiated delay time (DELAY), the initiator (AP2) sends the Nth SLS training PPDU sequence 83N from AP2 with the Nth directional receive beam (DIRECTIONAL RXBEAM N) at STA2 through the mmWave link. With this iterative process, the initiator sweeps through all N rounds of TXSS by having a separate announcement frame exchange 81, 82 and a different directional Rx beam at the responders for each SLS training PPDU sequence 83.

In the first responder feedback option, feedback may be sent after a negotiated time from the last (Nth) announcement frame exchange. For example, after the Nth SLS training PPDU sequence 83N is completed and a controlled backoff period expires (i.e., backoff counter becomes zero), the responder (STA1) can transmit a responder feedback message 84 to AP1 through the non-mmWave link (e.g., a 5 GHz band link), and AP1 acknowledges the responder feedback message 84 by transmitting an ACK message 85. As an alternative to waiting for the Nth SLS training PPDU sequence 83N to be completed, the responder (STA1) can initiate the feedback transmission by sending a responder feedback message via non-mmWave link for any TXSS round packet that is received by the responder (STA1), and then the initiator (AP1) decides if it will continue to finish all N rounds once it receives the feedback. In any case, if the responder initiates the feedback, then it requires either the delay to be known such that a negotiated time is possible or at least one training PPDU (with Tx beam index) is received. In other selected embodiments, the initiator may solicit the feedback after all N rounds are finished so that no delay information is required.

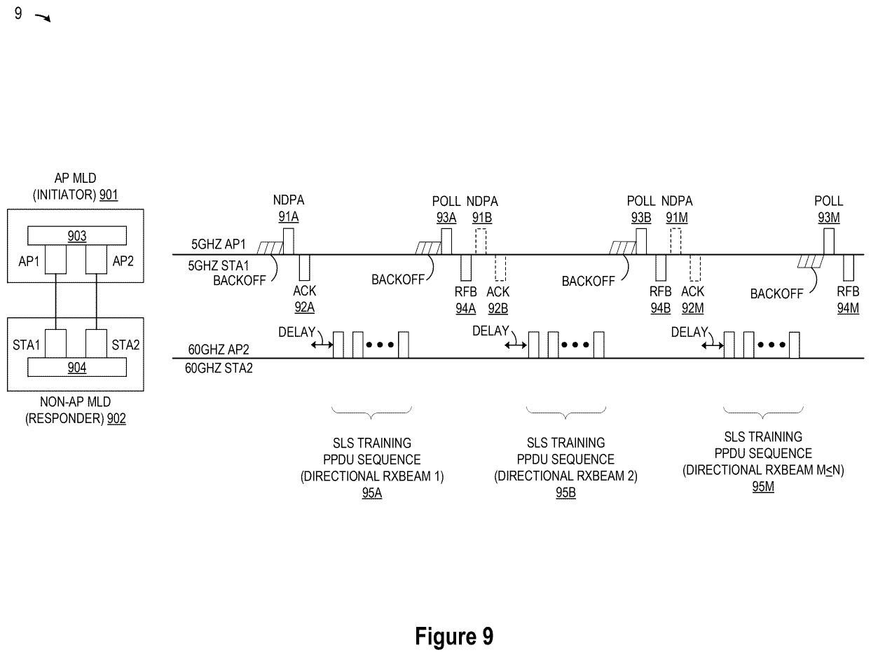

To provide additional details for an improved understanding of selected embodiments of the present disclosure, reference is now made to FIG. 9 which depicts an alternative first case example of a frame exchange sequence for an MLO-assisted SLS procedure 9 which is initiated on a non-mmWave link to establish a mmWave link between an initiator (AP MLD 901) and a responder (non-AP MLD 902) which have directional receivers and which have TX/RX beam reciprocity, where the initiator sends the training PPDU transmission rounds on the mmWave link with separate initiator poll requests to trigger the responder to switch receive beams and where a second responder feedback option is provided at the non-mmWave link in response to an initiator poll request after each training PPDU transmission round. In the depicted MLO-assisted SLS procedure 9, frames are exchanged between an AP MLD 901 (which includes a common MAC controller 903 and two wireless APs AP1, AP2) and a non-AP MLD 902 (which includes a common MAC controller 904 and two wireless STAs STA1, STA2). In selected embodiments, the common MAC controller 903 implements upper layer MAC functionalities of the AP MLD 901, and a link specific part of the AP MLD 901 (i.e., AP1, AP2) implements lower layer MAC functionalities of the AP MLD 901. In similar fashion, the common MAC controller 904 implements upper layer MAC functionalities of the non-AP MLD 902, and a link specific part of the non-AP MLD 902 (i.e., STA1, STA2) implements lower layer MAC functionalities of the non-AP MLD 902. As will be appreciated, the AP MLD 901 and non-AP MLD 902 may be implemented with any suitable controller design, such as a host processor and network interface connected to a MAC processor and PHY processor.

In the example frame exchange sequence for an MLO-assisted SLS procedure 9 where the initiator (AP MLD 901) and responder (non-AP MLD 902) have Tx/Rx beam reciprocity, the initiator (AP1) waits for an initial backoff period to expire (i.e., backoff counter becomes zero) before transmitting a first NDPA 91A to STA1 through the non-mmWave link (e.g., a 5 GHz band link) between AP1 and STA1, and STA1 acknowledges the first NDPA 91A by transmitting a first acknowledgement (ACK) 92A. After a negotiated delay time (DELAY) following the end of first NDPA/ACK frame exchange 91A, 92A, both AP2 and STA2 on the mmWave link are ready to do the first training PPDU sequence such that a first SLS training PPDU sequence 93A is communicated or conducted from AP2 to STA2 with a first directional receive beam (DIRECTIONAL RXBEAM 1) through the mmWave link (e.g., a 60 GHz band link). As disclosed, the initiator sends the first SLS training PPDU sequence 95A with a number of Nₜ training PPDUs, where Nₜ is a positive integer, and is received at the responder with the first directional receive beam (DIRECTIONAL RXBEAM 1). After the first SLS training PPDU sequence 95A is completed and a controlled backoff period expires (i.e., backoff counter becomes zero), the initiator (AP1) transmits a first polling packet 93A (e.g., a BF poll message or other suitable trigger frame) to STA1 through the non-mmWave link (e.g., a 5 GHz band link), and STA1 responds to the first polling packet 93A by sending a first responder feedback (RFB) message 94A through the non-mmWave link. Optionally, after the first polling packet 93A and responder feedback message 94A are completed and a predetermined IFS (i.e., short inter-frame space (SIFS)), the initiator (AP1) transmits a second NDPA 91B to STA1 through the non-mmWave link, the STA1 acknowledges the second NDPA 91B by transmitting a second ACK 92B, and then after a negotiated delay time (DELAY), the initiator (AP2) sends a second SLS training PPDU sequence 95B to the responder (STA2) with a second directional receive beam (DIRECTIONAL RXBEAM 2), the initiator (AP1) transmits a second polling packet 93B to STA1 through the non-mmWave link, and STA1 responds by sending a second RFB message 94B through the non-mmWave link. This process may be iteratively repeated until the initiator (AP1) transmits the Mth NDPA 91M to STA1 through the non-mmWave link, the STA1 acknowledges the Mth NDPA 91M by transmitting the Mth ACK 92M, the initiator (AP2) sends the Mth SLS training PPDU sequence 93M to STA2 with the Mth directional receive beam (DIRECTIONAL RXBEAM M), the initiator (AP1) transmits the Mth polling packet 93M to STA1, and STA1 responds by sending the Mth RFB message 94M through the non-mmWave link. With this iterative process, the initiator sweeps through M≤N rounds of TXSS by having a separate announcement frame exchange 91, 92 and polling/feedback exchange 93, 94 and a different directional Rx beam at the responders for each SLS training PPDU sequence 95. The initiator stops after the Mth TXSS round due to at least a meaningful feedback information with Tx beam ranking is received from the previous polled feedback 94A-94M, otherwise, it will continue till all N TXSS rounds are completed.

As indicated with the dashed lines, the announcement frame exchanges 91B-M, 92B-M can be omitted if no further new information is included in the announcement frame exchanges for any new TXSS round. In such embodiments, the responder can use the polling/feedback exchange 93, 94 as the indication to switch to next directional receive beam.

If the responder (STA2) does not detect any training PPDU, the responder will provide a responder feedback message frame without measurement info (or with a special number to indicate or QoS Null data), and the next TXSS round is followed to start a new round of training. In such embodiments, the initiator will determine if further TXSS round is needed based on the feedback.

In selected embodiments, the polling packet (e.g., 93A, 93B) can be in the same TXOP of the previous packet medium access (e.g., announcement frame exchange 91A, 92A) in the non-mmWave link, and the backoff for the polling packet is not needed if the training time for the previous SLS training PPDU sequences are within the TXOP duration of the previous packet medium access with backoff. Otherwise, the polling packet needs the medium access with new backoff.

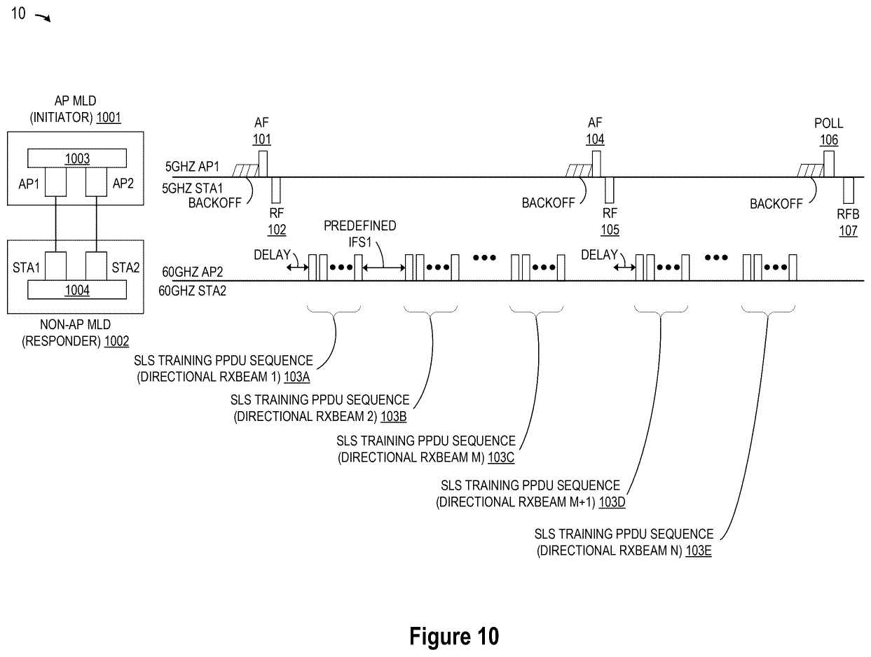

To provide additional details for an improved understanding of selected embodiments of the present disclosure, reference is now made to FIG. 10 which depicts another alternative first case example of a frame exchange sequence for an MLO-assisted SLS procedure 10 which is initiated on a non-mmWave link to establish a mmWave link between an initiator (AP MLD 1001) and a responder (non-AP MLD 1002) which have directional receivers and which have TX/RX beam reciprocity, where the initiator sends a plurality of training PPDU transmission rounds on the mmWave link after an initial fixed time delay (DELAY) without sending separate poll requests to trigger the responder to switch receive beams and where a third responder feedback option is provided at the non-mmWave link in response to an initiator poll request that is after the plurality of training PPDU transmission rounds. In the depicted MLO-assisted SLS procedure 10, frames are exchanged between an AP MLD 1001 (which includes a common MAC controller 1003 and two wireless APs AP1, AP2) and a non-AP MLD 1002 (which includes a common MAC controller 1004 and two wireless STAs STA1, STA2). In selected embodiments, the common MAC controller 1003 implements upper layer MAC functionalities of the AP MLD 1001, and a link specific part of the AP MLD 1001 (i.e., AP1, AP2) implements lower layer MAC functionalities of the AP MLD 1001. In similar fashion, the common MAC controller 1004 implements upper layer MAC functionalities of the non-AP MLD 1002, and a link specific part of the non-AP MLD 1002 (i.e., STA1, STA2) implements lower layer MAC functionalities of the non-AP MLD 1002. As will be appreciated, the AP MLD 1001 and non-AP MLD 1002 may be implemented with any suitable controller design, such as a host processor and network interface connected to a MAC processor and PHY processor.

In the example frame exchange sequence for an MLO-assisted SLS procedure 10 where the initiator (AP MLD 1001) and responder (non-AP MLD 1002) have Tx/Rx beam reciprocity, the initiator (AP1) waits for an initial backoff period to expire (i.e., backoff counter becomes zero) before transmitting a first announcement frame (AF) 101 to STA1 through the non-mmWave link (e.g., a 5 GHz band link) between AP1 and STA1, and STA1 responds by sending a response frame (RF) 102. After a negotiated delay time (DELAY) following the end of announcement frame exchange 101, 102, both AP2 and STA2 on the mmWave link are ready to send a plurality of first training PPDU sequences 103A-103C that are separated from one another by a predefined IFS (IFS1) so that the responder (STA2) is configured to automatically switch the directional receiver beam without requiring a separate announcement frame exchange or polling frame. In such embodiments where the time delay (DELAY) between announcement frame exchange 101, 102 and the first training PPDU transmission 103A is a fixed delay (e.g., a predefined IFS), the initiator (AP1) does not need to send other announcement frame exchange or polling frame as an indicator for the responder (STA2) to switch the Rx beam. Instead, the responder (STA2) can calculate the RX beam switch time based on the fixed delay (e.g., DELAY), the training PPDU duration, number of Tx beams, and the interval between two training PPDUs (e.g., PREDEFINED IFS1). As will be appreciated, the disclosed MLO-assisted SLS procedure 10 will require the fixed delay to be allowed with a proper medium access mechanism.

As disclosed, the initiator (AP2) sends the first SLS training PPDU sequence 103A with a number of Nₜ training PPDUs (each with a separate transmit beam), where Nₜ is a positive integer, and is received at the responder (STA2) with the first directional receive beam (DIRECTIONAL RXBEAM 1). After the first SLS training PPDU sequence 103A is completed and a predefined IFS (IFS1) expires, the initiator (AP2) transmits a second SLS training PPDU sequence 103B with a number of Nₜ training PPDUs applied with the same Nₜ transmit beams which is received at the responder (STA2) with the second directional receive beam (DIRECTIONAL RXBEAM 2), all without requiring that the initiator (AP1) transmit a polling packet to STA1 through the non-mmWave link. The training process continues with the initiator (AP2) sequentially sending one or more additional SLS training PPDU sequences 103M with a number of Nₜ training PPDUs that are received at the responder (STA2) switching to the Mth directional receive beam (DIRECTIONAL RXBEAM M).

As will be appreciated, there may be cases where one announcement frame exchange 101, 102 is not able to reserve a TXOP that is long enough to cover the whole training sequence before the feedback is received. For example, if the TXOP covers only M<N TXSS rounds with each TXSS round sweeping through Nₜ Tx beams with the Rx beam fixed in the mmWave link, then one or more additional, subsequent announcement frame exchanges may be used to initiate new TXOP(s) for the remaining TXSS rounds. In FIG. 10, this is illustrated with initiator (AP1) which waits for a backoff period to expire after the Mth SLS training PPDU sequence 103M before transmitting a second announcement frame (AF) 104 to STA1 through the non-mmWave link between AP1 and STA1, and STA1 responds by sending a response frame (RF) 105. After a negotiated delay time (DELAY) following the end of announcement frame exchange 104, 105, AP2 and STA2 are ready to send one or more additional first training PPDU sequences 103D-103E that are separated from one another by the predefined IFS (IFS1) so that the responder (STA2) is configured to automatically switch the directional receiver beam without requiring a separate announcement frame exchange or polling frame.

As disclosed herein the predefined IFS (IFS1) may be a fixed IFS that has the same duration (or a different duration) from the time delay (DELAY) and that is used for switching the initiator Tx beam and responder Rx beam. In addition, the announcement frame will indicate the directional Rx beam/AWV index.

Instead of polling the responder (STA1) to provide feedback after each SLS training PPDU sequence 103A-E, the initiator (AP1) may wait for a backoff period to expire after the Nth SLS training PPDU sequence 103E before transmitting a single polling packet 106 to the responder (STA1) which responds by sending a responder feedback message (RFB) 107 through the non-mmWave link. In this way, the initiator (AP1) can use a beamforming polling packet (or trigger frame if multiple responders) to solicit feedback. Alternatively, the responder (STA1) can initiate the feedback in the non-mmWave link after the TXSS round it receives at least one training PPDU. As will be appreciated, the backoff for the polling packet can be skipped if it is within the TXOP of the previous announcement frame exchange.

As will be appreciated, FIG. 10 depicts a MLO-assisted SLS procedure 10 where there is Tx/Rx beam reciprocity, but in cases when the TX/Rx has no reciprocity, a similar training procedure may be performed in the reverse training direction from the responder (1002) to the initiator (1001). In such embodiments, the responder (STA1) may initiate an announcement frame exchange is made on the non-mmWave link, and then wait for a fixed delay time (DELAY) before the responder (STA2) sends a plurality of SLS training PPDU sequences to the initiator (AP2) on the mmWave link after without requiring a separate announcement frame exchange for each SLS training PPDU sequence. Instead, the initiator (AP2) can calculate the RX beam switch time based on the fixed delay (e.g., DELAY), the training PPDU duration, number of Tx beams, and the interval between two training PPDUs.

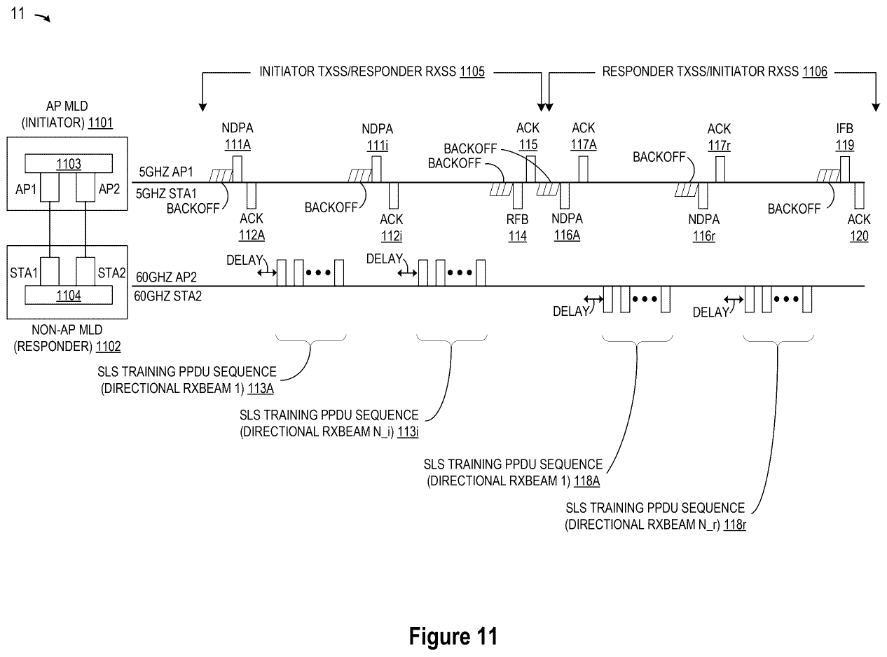

To provide additional details for an improved understanding of selected embodiments of the present disclosure, reference is now made to FIG. 11 which depicts a second case example of a frame exchange sequence for an MLO-assisted SLS procedure 11 which is initiated on a non-mmWave link to establish a mmWave link between an initiator (AP MLD 1101) and a responder (non-AP MLD 1102) which have directional receivers and which do not have TX/RX beam reciprocity, where a first feedback option is used for the responder (STA1) to send responder feedback after the initiator (AP2) sweeps through all N_i TXSS rounds, and for the initiator (AP1) to send initiator feedback after the responder (STA2) sweeps through all N_r TXSS rounds. In particular, the responder (STA1) sends feedback 114 at the non-mmWave link at a negotiated time after the initiator (AP2) sends the SLS training PPDU transmission rounds (113A-i) or at least after one training PPDU is received at the responder on the mmWave link. In addition, the initiator (AP1) sends feedback 119 at the non-mmWave link at a negotiate time after the responder (STA2) sends the SLS training PPDU transmission rounds (118A-r) or at least after one training PPDU is received at the initiator on the mmWave link. In this scenario where the initiator and responder do not have the Tx/Rx beam reciprocity, N_i and N_r are the total Rx Beams during, respectively, initiator TXSS and responder TXSS operations. In other selected embodiments, the initiator (AP1) may solicit the feedback from the responder (STA1) in non-mmWave link after the N_ith training PPDU sequence 113i, and the responder (STA1) may solicit the feedback from the initiator (AP1) in non-mmWave link after the N_rth training PPDU sequence 118r.

In the depicted MLO-assisted SLS procedure 11, frames are exchanged between an AP MLD 1101 (which includes a common MAC controller 1103 and two wireless APs AP1, AP2) and a non-AP MLD 1102 (which includes a common MAC controller 1104 and two wireless STAs STA1, STA2). In selected embodiments, the common MAC controller 1103 implements upper layer MAC functionalities of the AP MLD 1101, and a link specific part of the AP MLD 1101 (i.e., AP1, AP2) implements lower layer MAC functionalities of the AP MLD 1101. In similar fashion, the common MAC controller 1104 implements upper layer MAC functionalities of the non-AP MLD 1102, and a link specific part of the non-AP MLD 1102 (i.e., STA1, STA2) implements lower layer MAC functionalities of the non-AP MLD 1102. As will be appreciated, the AP MLD 1101 and non-AP MLD 1102 may be implemented with any suitable controller design, such as a host processor and network interface connected to a MAC processor and PHY processor.

In the example frame exchange sequence for an MLO-assisted SLS procedure 11, the initiator (AP MLD 1101) and responder (non-AP MLD 1102) do not have Tx/Rx beam reciprocity. As a result, an initiator TXSS/responder RXSS sequence 1105 is performed first, followed by a responder TXSS/initiator RXSS sequence 1106. In the initiator TXSS/responder RXSS sequence 1105, the initiator (AP2) sweeps through all N_i rounds of the SLS training PPDUs (113A-113i) to perform the initiator TXSS transmission and responder RXSS detection using a different directional receive beam for each initiator TXSS round in response to a frame exchange 111, 112. And in the responder TXSS/initiator RXSS sequence 1106, the responder (STA2) sweeps through all N_r rounds of the SLS training PPDUs (118A-118r) to perform the responder TXSS transmission and initiator RXSS detection using a different directional receive beam for each responder TXSS round in response to a frame exchange 116, 117.

In particular, the initiator TXSS/responder RXSS sequence 1105 starts after an initial backoff period expires when the initiator (AP1) transmits a first NDPA 111A to the responder (STA1) through the non-mmWave link (e.g., a 5 GHz band link) between AP1 and STA1, and STA1 acknowledges the first NDPA 111A by transmitting a first acknowledgement (ACK) 112A. The initiator and the responder (e.g., AP2 and STA2, respectively) negotiate a delay time (DELAY) required between the end of first NDPA/ACK frame exchange 111A, 112A and the start of a first training PPDU in a mmWave link (e.g., a 60 GHz band link) between AP2 and STA2. The negotiated time and the end time of the first NDPA/ACK frame exchange 111A, 112A decide when the first training PPDU in the mmWave link starts. After the delay time, both AP2 and STA2 on the mmWave link are ready to do the SLS training PPDU sequence 113A from AP2 to STA2 with a first directional receive beam (DIRECTIONAL RXBEAM 1) through the mmWave link (e.g., a 60 GHz band link). As disclosed, the initiator sends the first SLS training PPDU sequence 113A a number of N_{t,i} training PPDUs, where N_{t,i} is a positive integer, and is received at the responder with the first directional receive beam (DIRECTIONAL RXBEAM 1). After the first SLS training PPDU sequence 113A is completed and a controlled backoff period expires (i.e., backoff counter becomes zero), the initiator (AP1) transmits one or more additional NDPA(s) 111i to STA1 through the non-mmWave link, the STA1 acknowledges the additional NDPA(s) 111i by transmitting one or more additional ACK(s) 112i, and then after a negotiated delay time (DELAY), the initiator (AP2) sends, for each frame exchange 111i, 112i, an additional SLS training PPDU sequence 113i with a corresponding N_ith directional receive beam (DIRECTIONAL RXBEAM N_i) at STA2 through the mmWave link. With this iterative process, the initiator sweeps through all N_i rounds of TXSS by having a separate announcement frame exchange 111A-i, 112A-i and a different directional Rx beam at the responders for each SLS training PPDU sequence 113A-i. In the example first feedback option, feedback may be sent at the end of the initiator TXSS/responder RXSS sequence 1105. For example, after the N_ith SLS training PPDU sequence 113i is completed and a controlled backoff period expires, the responder (STA1) can transmit a responder feedback (RFB) message 114 to AP1 through the non-mmWave link, and AP1 acknowledges the responder feedback message 114 by transmitting an ACK message 115.

In similar fashion, the responder TXSS/initiator RXSS sequence 1106 starts after the initiator TXSS/responder RXSS sequence 1105 when the responder (STA1) transmits a first NDPA 116A to the initiator (AP1) through the non-mmWave link between AP1 and STA1, and the initiator (AP1) acknowledges the first NDPA 116A by transmitting a first acknowledgement (ACK) 117A to the responder (STA1). The responder and the initiator (e.g., STA2 and AP2, respectively) negotiate a delay time (DELAY) required between the end of first NDPA/ACK frame exchange 116A, 117A and the start of a first training PPDU in a mmWave link (e.g., a 60 GHz band link) between STA2 and AP2. The negotiated time and the end time of the first NDPA/ACK frame exchange 116A, 117A decide when the first training PPDU in the mmWave link starts. After the delay time, both STA2 and AP2 on the mmWave link are ready to do the first SLS training PPDU sequence 118A from STA2 to AP2 with a first directional receive beam (DIRECTIONAL RXBEAM 1) through the mmWave link. As disclosed, the responder sends the first SLS training PPDU sequence 118A with a number of N_{t,r} training PPDUs, where N_{t,r} is a positive integer, and is received at the initiator with the first directional receive beam (DIRECTIONAL RXBEAM 1). After the first SLS training PPDU sequence 118A is completed and a controlled backoff period expires (i.e., backoff counter becomes zero), the responder (STA1) transmits one or more additional NDPA(s) 116r to AP1 through the non-mmWave link, the AP1 acknowledges the additional NDPA(s) 116r by transmitting one or more additional ACK(s) 117r, and then after a negotiated delay time (DELAY), the responder (STA2) sends, for each frame exchange 116r, 117r, a TXSS round by transmitting an additional SLS training PPDU sequence 118r with a corresponding N_rth directional receive beam (DIRECTIONAL RXBEAM N_r) at AP2 through the mmWave link. With this iterative process, the initiator sweeps through all N_r rounds of TXSS by having a separate announcement frame exchange 116A-r, 117A-r and a different directional Rx beam at the responders for each SLS training PPDU sequence 118A-r. In the example first feedback option, feedback may be sent at the end of the responder TXSS/initiator RXSS sequence 1106. For example, after the N_rth SLS training PPDU sequence 118r is completed and a controlled backoff period expires, the initiator (AP1) can transmit an initiator feedback (IFB) message 119 to the responder (STA1) through the non-mmWave link, and the responder (STA1) acknowledges the initiator feedback message 119 by transmitting an ACK message 120. Thus, the initiator and responder TXSS can be done independently as illustrated in FIG. 11. And if the N_i=N_r and all TXSS rounds are to be swept, each initiator/responder TXSS round can also be done sequentially as illustrated in FIG. 5.

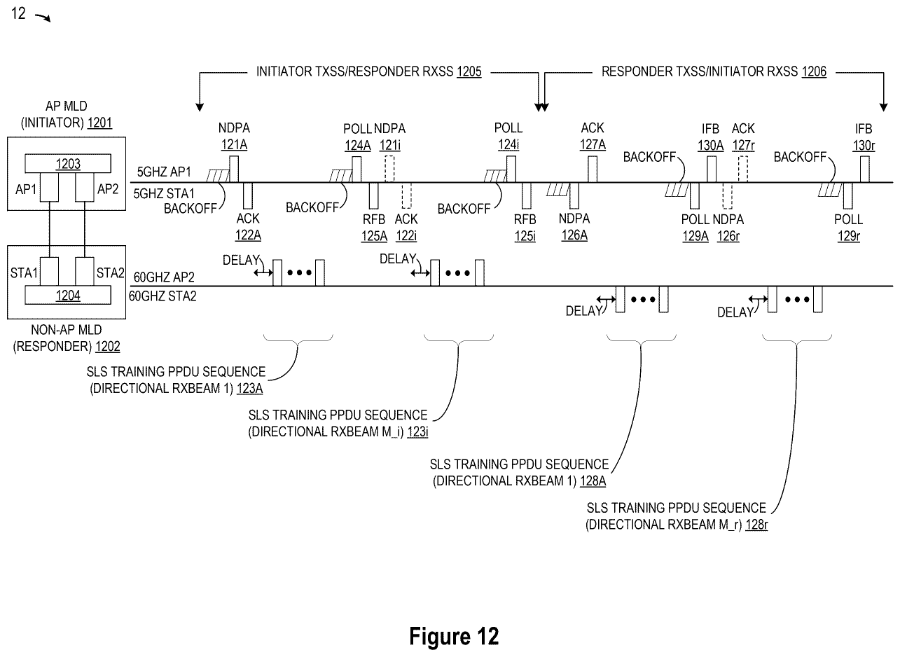

To provide additional details for an improved understanding of selected embodiments of the present disclosure, reference is now made to FIG. 12 which depicts an alternative second case example of a frame exchange sequence for an MLO-assisted SLS procedure 12 which is initiated on a non-mmWave link to establish a mmWave link between an initiator (AP MLD 1201) and a responder (non-AP MLD 1202) which have directional receivers and which do not have TX/RX beam reciprocity, where a second feedback option is used for the responder (STA1) to send responder feedback in response to a initiator poll request on the non-mmWave link after each training PPDU transmission round transmitted by the initiator (AP2), and for the initiator (AP1) to send initiator feedback in response to a responder poll request on the non-mmWave link after each training PPDU transmission round transmitted by the responder (STA2). In particular, the transmitter of each training PPDU triggers or polls the receiver for feedback so that the transmitter can decides on whether continue by transmitting another round of TXSS. Due to uncertainty on how many training PPDU rounds will be needed for the initiator TXSS operations, it is more straightforward that the responder TXSS starts after the whole sequence of transmitter TXSS operations is finished.

In the depicted MLO-assisted SLS procedure 12, frames are exchanged between an AP MLD 1201 (which includes a common MAC controller 1203 and two wireless APs AP1, AP2) and a non-AP MLD 1202 (which includes a common MAC controller 1204 and two wireless STAs STA1, STA2). In selected embodiments, the common MAC controller 1203 implements upper layer MAC functionalities of the AP MLD 1201, and a link specific part of the AP MLD 1201 (i.e., AP1, AP2) implements lower layer MAC functionalities of the AP MLD 1201. In similar fashion, the common MAC controller 1204 implements upper layer MAC functionalities of the non-AP MLD 1202, and a link specific part of the non-AP MLD 1202 (i.e., STA1, STA2) implements lower layer MAC functionalities of the non-AP MLD 1202. As will be appreciated, the AP MLD 1201 and non-AP MLD 1202 may be implemented with any suitable controller design, such as a host processor and network interface connected to a MAC processor and PHY processor.

In the example frame exchange sequence for an MLO-assisted SLS procedure 12, the initiator (AP MLD 1201) and responder (non-AP MLD 1202) do not have Tx/Rx beam reciprocity. As a result, an initiator TXSS/responder RXSS sequence 1205 is performed first, followed by a responder TXSS/initiator RXSS sequence 1206. In the initiator TXSS/responder RXSS sequence 1205, the initiator (AP2) sweeps through M_i (M_i≤N_i) rounds of the SLS training PPDUs (123A-123i) to perform the initiator TXSS and responder RXSS using a different directional receive beam for each TXSS round in response to a frame exchange 121, 122. And in the responder TXSS/initiator RXSS sequence 1206, the responder (STA2) sweeps through M_r (M_r≤N_r) rounds of the SLS training PPDUs (128A-128r) to perform the responder TXSS and initiator RXSS using a different directional receive beam for each TXSS round in response to a frame exchange 126, 127.

In particular, the initiator TXSS/responder RXSS sequence 1205 starts after an initial backoff period expires when the initiator (AP1) transmits a first NDPA 121A to the responder (STA1) through the non-mmWave link (e.g., a 5 GHz band link) between AP1 and STA1, and STA1 acknowledges the first NDPA 121A by transmitting a first acknowledgement (ACK) 122A. Based on the NDPA/ACK frame exchange 121A, 122A, the initiator and the responder (e.g., AP2 and STA2, respectively) negotiate a delay time (DELAY) required between the end of first NDPA/ACK frame exchange 121A, 122A and the start of a first training PPDU in a mmWave link (e.g., a 60 GHz band link) between AP2 and STA2. The negotiated time and the end time of the first NDPA/ACK frame exchange 121A, 122A decide when the first training PPDU in the mmWave link starts. After the delay time, both AP2 and STA2 on the mmWave link are ready to do the first SLS training PPDU sequence 123A from AP2 with a first directional receive beam (DIRECTIONAL RXBEAM 1) at STA2 through the mmWave link (e.g., a 60 GHz band link). As disclosed, the initiator sends the first SLS training PPDU sequence 123A with a number of N_{t,i} training sequences, where N_{t,i} is a positive integer, and is received at the responder with the first directional receive beam (DIRECTIONAL RXBEAM 1). After the first SLS training PPDU sequence 123A is completed and a controlled backoff period expires (i.e., backoff counter becomes zero), the initiator (AP1) transmits a first polling packet 124A (e.g., a BF poll packet or other suitable trigger frame) to the responder (STA1) through the non-mmWave link, and the responder (STA1) responds to the first polling packet 124A by sending the first responder feedback message 125A. In order to set up an additional initiator TXSS round, the initiator (AP1) may transmit one or more additional NDPAs 121i to STA1 through the non-mmWave link which the responder (STA1) acknowledges by transmitting one or more additional ACKs 122i, and then after a negotiated delay time (DELAY), the initiator (AP2) sends, for each frame exchange 121i, 122i, an additional SLS training PPDU sequence 123i from AP2 with a corresponding M_ith directional receive beam (DIRECTIONAL RXBEAM M_i) at STA2 through the mmWave link. And after each SLS training PPDU sequence 123i is completed and a controlled backoff period expires, the initiator (AP1) transmits an ith polling packet 124i to the responder (ST1) through the non-mmWave link, and the responder (STA1) responds to the ith polling packet 124i by sending the ith responder feedback message 125i to the initiator (AP1). With this iterative process, the initiator sweeps through M_i rounds of TXSS with a different directional Rx beam at the responders for each SLS training PPDU sequence 123A-i. As indicated with the dashed lines the announcement frame exchanges 121i, 122i can be omitted if no further new information is included in the announcement frame exchanges for any new initiator TXSS round. In such embodiments, the responder can use the preceding polling/feedback exchange (e.g., 124A, 125A) as the indication to switch to next directional receive beam. In the initiator TXSS/responder RXSS sequence 1205, M_i≤N_i for the initiator TXSS rounds and N_i is the negotiated total Rx beams for the responder RXSS.

In similar fashion, the responder TXSS/initiator RXSS sequence 1206 starts after the initiator TXSS/responder RXSS sequence 1205 when the responder (STA1) waits for a controlled backoff period to expire before transmitting a first NDPA 126A to the initiator (AP1) through the non-mmWave link between AP1 and STA1, and the initiator (AP1) acknowledges the first NDPA 126A by transmitting a first acknowledgement (ACK) 127A to the responder (STA1). Based on the NDPA/ACK frame exchange 126A, 127A, the initiator and the responder (e.g., STA2 and AP2, respectively) negotiate a delay time (DELAY) required between the end of first NDPA/ACK frame exchange 126A, 127A and the start of a first sounding in a mmWave link (e.g., a 60 GHz band link) between STA2 and AP2. The negotiated time and the end time of the first NDPA/ACK frame exchange 126A, 127A decide when the first training PPDU in the mmWave link starts. After the delay time, both STA2 and AP2 on the mmWave link are ready to do the first SLS training PPDU sequence 128A from STA2 to AP2 with a first directional receive beam (DIRECTIONAL RXBEAM 1) through the mmWave link. As disclosed, the responder sends the first SLS training PPDU sequence 128A with a number of N_{t,r} training PPDUs, where N_{t,r} is a positive integer, and is received at the initiator with the first directional receive beam (DIRECTIONAL RXBEAM 1). After the first SLS training PPDU sequence 128A is completed and a controlled backoff period expires, the responder (STA1) transmits a first polling packet 129A to the initiator (AP1) through the non-mmWave link, and the initiator (AP1) responds to the first polling packet 129A by sending the first initiator feedback message 130A. In order to set up additional responder TXSS transmission rounds, the responder (STA1) may transmit one or more additional NDPAs 126r to the initiator (AP1) through the non-mmWave link which the initiator (AP1) acknowledges by transmitting one or more additional ACKs 127r, and then after a negotiated delay time (DELAY), the responder (STA2) sends, for each frame exchange 126r, 127r, an additional SLS training PPDU sequence 128r from STA2 with a corresponding M_rth directional receive beam (DIRECTIONAL RXBEAM M_r) at AP2 through the mmWave link. And after each SLS training PPDU sequence 128r is completed and a controlled backoff period expires, the responder (STA1) transmits an rth polling packet 129r to the initiator (AP1) through the non-mmWave link, and the initiator (AP1) responds to the rth polling packet 119r by sending the rth initiator feedback message 130r to the responder (STA1). With this iterative process, the responder sweeps through M_r rounds of TXSS by having a separate announcement frame exchange 126A-r, 127A-r and a different directional Rx beam at the initiators for each SLS training PPDU sequence 128-r. As indicated with the dashed lines the announcement frame exchanges 126r, 127r can be omitted if no further new information is included in the announcement frame exchanges for any new responder TXSS round. In such embodiments, the responder can use the preceding polling/feedback exchange (e.g., 129A, 130A) as the indication to switch to next directional receive beam. In the responder TXSS/initiator RXSS sequence 1206, M_r≤N_r for the responder TXSS rounds, and N_r is the negotiated total Rx beams for the initiator RXSS.

In reference to the initiator TXSS/responder RXSS sequence 1205, if none of the training PPDUs (e.g., 123A) are detected from the initiator TXSS rounds, the responder (STA1) may be configured to respond with a feedback frame (e.g., 125A) without any measurement info, and then the next the announcement frame exchange (e.g., 121i, 122i) may initiate another TXSS round.

In selected embodiments, the polling packets (e.g., 124A, or 129A) can be in the same TXOP of the previous packet medium access (e.g., announcement frame exchange 121A/122A, or 126A/127A) and the backoff of the polling packets can be skipped as in the description for FIG. 9. And as indicated with the dashed lines, the announcement frame exchange for the subsequent TXSS round can be skipped if no further new information is needed to negotiate for the next TXSS round.

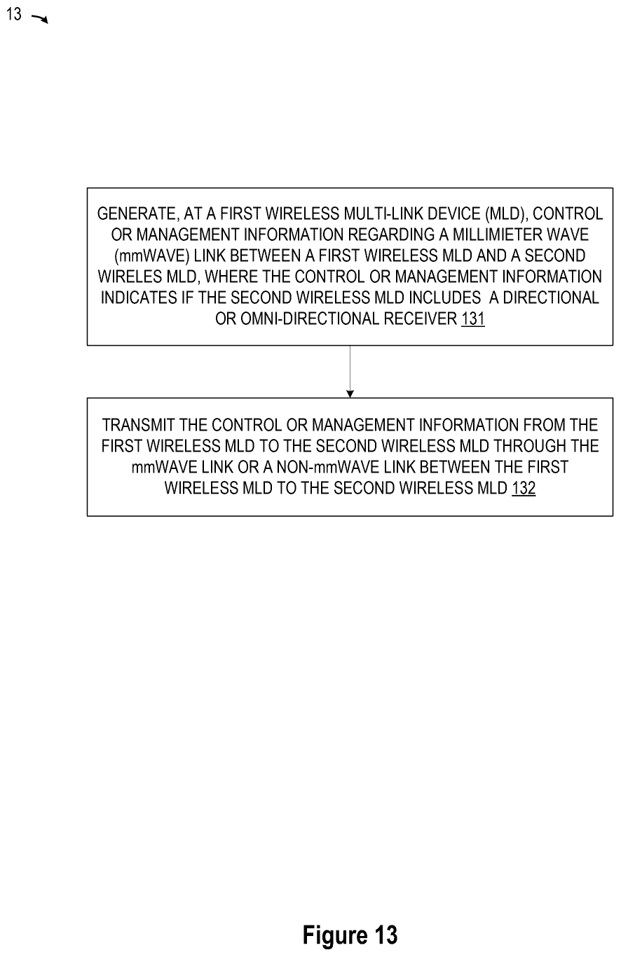

To provide an improved understanding of selected embodiments of the present disclosure, reference is now made to FIG. 13 which illustrates a process flow diagram of a method for wireless communications. At step 131, a first wireless multi-link device (MLD) generates control or management information regarding a millimeter wave (mmWave) link between the first wireless MLD and a second wireless MLD, where the control or management information indicates if the second wireless MLD includes a directional or omni-directional receiver. At step 132, the first wireless MLD transmits the control or management information regarding the mmWave link to the second wireless MLD through the mmWave link or a non-mmWave link between the first wireless MLD and the second wireless MLD. In selected embodiments, the first wireless MLD includes an access point (AP) MLD that includes a wireless AP, and the second wireless MLD includes a non-AP MLD that includes a non-AP station (STA). In selected embodiments, the non-mmWave link includes one of a 2.4 Gigahertz (GHz) link, a 5 GHz link, or a 6 GHz link, and the mmWave link includes a 45 GHz link or a 60 GHz link. In selected embodiments, the control or management information regarding the mmWave link is transmitted to the second wireless MLD through the non-mmWave link between the first wireless MLD and the second wireless MLD. In selected embodiments, the control or management information regarding the mmWave link includes link connection establishment information regarding the mmWave link. In selected embodiments, the control or management information regarding the mmWave link includes mmWave beamforming training announcement information regarding the mmWave link that initiates a sector sweep training between the first wireless MLD and the second wireless MLD. In selected embodiments, the control or management information regarding the mmWave link includes a null data packet announcement (NDPA) frame. In selected embodiments, the first wireless MLD transmits the control or management information regarding the mmWave link to the second wireless MLD through the non-mmWave link between the first wireless MLD and the second wireless MLD. In selected embodiments, the first wireless MLD sends sector sweep training PPDUs over the mmWave link to the second wireless MLD under control of the control or management information, and the second wireless MLD transmits a signal quality measurement of the sector sweep training PPDUs received over the mmWave link. In some embodiments, the first wireless MLD includes a non-AP MLD that includes a non-AP station (STA), the non-AP station includes the controller and the wireless transceiver, and the second wireless MLD includes an AP MLD that includes a wireless AP. In some embodiments, the first wireless MLD is compatible with an Institute of Electrical and Electronics Engineers (IEEE) 802.11 protocol.

In accordance with the present disclosure, there is provided a method of MLO-assisted analog beam training (e.g., a sector level sweep (SLS) training) for a mmWave link between first and second wireless devices that is performed when the mmWave link has not been established or a beam/link failure is detected and retrain is requested. In the method, a first wireless device transmits an announcement frame (or a setup frame or control frame) at a non-mmWave link that is received and acknowledged by the second wireless device transmitting an acknowledgement (response) frame or another announcement frame on the same non-mmWave link to complete the announcement frame exchange. Using the announcement frame exchange, the first and second wireless devices negotiate all the training parameters needed for the subsequent SLS training, including the number of training PPDU/Beams, the transmit sector sweep (TXSS) and/or receive sector sweep (RXSS) configurations, and directional or omni-directional Rx info if both are an option, etc. After a specified delay, the first wireless device transmits a training PPDU sequence at the mmWave link, and the second wireless device detects and measures a training PPDU signal quality to determine the transmit AWV/beam ranking of the first wireless device and the corresponding best Rx AWV/beam at the second wireless device. In selected embodiments, the specified delay may be a predefined IFS or a medium access time with random backoff based on medium status. In selected embodiments, the first wireless device transmits the training PPDU sequence by applying a different Tx AWV/beamtraining to each training PPDU. In selected embodiments, the second wireless device may use an omni-directional beam to detect and receive the training PPDU, provided that the training PPDU design which uses an omni-directional beam has good enough sensitivity margin over any data PPDU with optimal Tx/Rx beam pair applied such that the range will not be limited in the TXSS beam training. In selected embodiments where the first and second wireless devices have Tx/Rx beam reciprocity, the training PPDU may include a training (TRN) field at the end of each PPDU for the second wireless device to train the Rx beams, where an omni-directional Rx beam is only applied on the non-TRN field(s) of the training PPDU, in which case the best Rx beam of the second wireless device will be used as the best Tx beam on the reverse direction link, and the best Tx beam of the first wireless device will be the best Rx beam on the reverse direction link. In other embodiments, the second wireless device can use a directional beam to detect and receive each training PPDU if the training PPDU design using omni-directional beam doesn't have enough sensitivity margin over the data PPDU with optimal Tx/Rx beam pair applied. In such embodiments, the first wireless device may use a new announcement frame exchange or a polling packet for the feedback of the previous training PPDU sequence in the non-mmWave link as an indication for the second wireless device to switch to a new Rx beam in mmWave link. The first wireless device can initiate multiple rounds of training PPDU sequence with the same Tx AWVs/Beams applied between the multiple rounds, and so that the second wireless device uses different Rx directional beams for the different TXSS rounds. When transmitting the training PPDU sequence, the first wireless device can sweep through N rounds of training PPDU sequences where N is the number of Rx beams at the second device, or the first wireless device can stop sweeping the rounds of training PPDU sequence after M≤N rounds based on the feedback contents. After receiving the training PPDU sequence, the second wireless device transmits a feedback frame to the first wireless device which contains the Tx AWV/beam ranking info of the first wireless device. In selected embodiments, the feedback frame transmission from the second wireless device can be initiated by the second wireless device via medium access on the non-mmWave link. Alternatively, the feedback frame transmission from the second wireless device can be solicited by the first wireless device via a polling packet on the non-mmWave link. If the second wireless device does not detect any packet from the previous training PPDU sequence, the second wireless device can use a special number to indicate there is no measurement information in the feedback frame when solicited by the first wireless device. Alternatively, the second wireless device does nothing for the feedback frame transmission when initiated by itself. If the first and second wireless devices have Tx/Rx beam reciprocity in the mmWave link, the training PPDU sequence is transmitted only from the first wireless device to the second wireless device. However, if the first and second wireless devices do not have TX/RX beam reciprocity, the second wireless device may optionally transmit a training PPDU sequence at the mmWave link to train the reverse direction, and the first wireless device may detect and measure a training PPDU signal quality to determine the transmit AWV/beam ranking of the second wireless device and the corresponding best Rx AWV/beam at the first wireless device. In such non-reciprocity embodiments, the second wireless device may transmit a training PPDU sequence with different Tx AWVs to the first wireless device for determining the Tx AWV/Beam ranking. In this case, the second wireless device can transmit the training PPDU sequentially with a predefined IFS after the training PPDU sequence of the first wireless device, or independently with separate announcement frame exchange preceding the training PPDU sequence. In such embodiments, the first wireless device can either use omni-directional beam or directional beam to detect and measure the training PPDU from the second wireless device. In addition, the first wireless device may transmit a feedback frame to the second wireless device which contains the Tx AWV/beam ranking info of the second wireless device. In selected embodiments, the feedback frame transmission from the first wireless device can be initiated by the first wireless device on the non-mmWave link or can be solicited by the second wireless device via a polling packet on the non-mmWave link. In other embodiments where the second wireless device uses directional Rx beams and multiple training PPDU sequence are transmitted from the first wireless device, the second wireless device can initiate the feedback either right after the training PPDU sequence round it receives, or at the end of all the predefined N rounds with a negotiated time which requires the delay time to be known. However, there is no requirement on the delay time when the feedback frame is solicited by the first wireless device.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner. It should also be noted that at least some of the operations for the methods described herein may be implemented using software instructions stored on a computer useable storage medium for execution by a computer. As an example, an embodiment of a computer program product includes a computer useable storage medium to store a computer readable program. The computer-useable or computer-readable storage medium can be an electronic, magnetic, optical, electromagnetic, infrared, or semiconductor system (or apparatus or device). Examples of non-transitory computer-useable and computer-readable storage media include a semiconductor or solid-state memory, magnetic tape, a removable computer diskette, a random-access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD). Alternatively, embodiments of the invention may be implemented entirely in hardware or in an implementation containing both hardware and software elements. In embodiments which use software, the software may include but is not limited to firmware, resident software, microcode, etc.

By now it should be appreciated that there has been provided a wireless communication apparatus, method, and system for performing analog beamforming training to establish a mmWave link by a first wireless multi-link device (MLD) in accordance with Institute of Electrical and Electronics Engineers (IEEE) 802.11 protocol and other next-generation wireless protocols. In the disclosed methodology, a first wireless MLD and a second wireless MLD generate training control information regarding a millimeter wave (mmWave) link between the first and second wireless MLDs, where the training control information includes a first indicator if the second wireless MLD includes a directional receiver and includes a second indicator if the second wireless MLD includes an omni-directional receiver. In selected embodiments, the training control information specifies a plurality of analog beamforming training parameters comprising a specified number of training PPDUs, a specified transmit sector sweep (TXSS) configuration, a specified receive sector sweep (RXSS) configuration, and indicator information specifying if the second wireless MLD includes an omni-directional receiver or a directional receiver. In selected embodiments, the training control information is generated by the first wireless MLD which transmits a first control frame regarding the mmWave link to the second wireless MLD through the non-mmWave link between the first wireless MLD and the second wireless MLD, and then receives an acknowledgement response message sent by the second wireless MLD through the non-mmWave link in response to the second wireless MLD receiving the training control information, where information contained in the first control frame and acknowledgement response message are used by the first wireless MLD and second wireless MLD to negotiate the training control information. In addition, the disclosed methodology includes the first wireless MLD transmitting a first training PPDU sequence to the second wireless MLD through the mmWave link under control of the training control information. In selected embodiments, the first wireless MLD transmits the first training PPDU sequence after waiting for a specified time delay after receiving the acknowledgement response message. In such embodiments, the specified time delay may be a predefined Interframe space (IFS) or a medium access time with random backoff based on medium status. In other selected embodiments, the first wireless MLD transmits the first training PPDU sequence by applying a different transmit AWV or beam to each training PPDU in the first training PPDU sequence. In other such embodiments, the first wireless MLD may generate the first training PPDU sequence wherein each training PPDU comprises a non-training field and a training field, and where the second wireless MLD uses an omni-directional beam receiver to detect and measure only the non-training field from each training PPDU. In such embodiments, the second wireless MLD may use directional receive beams to measure the training field from each detected training PPDU and to determine the receive beam ranking for reverse direction Tx beam ranking when there is Tx/Rx beam reciprocity between the first and second wireless MLDs. The disclosed methodology also includes the first wireless MLD receiving a first signal quality feedback message from the second wireless MLD through the non-mmWave link in response to the second wireless MLD detecting and measuring a first signal quality measure based on the first training PPDU sequence received by the second wireless MLD under control of the training control information. In the disclosed methodology, the first wireless MLD uses the first signal quality measure to determine a plurality of transmit antenna weight vectors (AWV) or beam ranking for analog beamforming of the first wireless MLD. In such embodiments, the second wireless MLD may use an omni-directional beam receiver to detect and measure the first signal quality measure from the first training PPDU sequence. In other such embodiments, the second wireless MLD may use a directional beam receiver to detect and measure the first signal quality measure from the first training PPDU sequence. In selected embodiments, the first wireless MLD uses an announcement frame exchange or polling packet to solicit the second wireless MLD to transmit the first signal quality feedback message as a reference indicator to configure different receive directional beams for the different rounds training PPDU sequences. In selected embodiments, the first wireless MLD transmits the first training PPDU sequence one or more times to the second wireless MLD through the mmWave link under control of the training control information until receiving the first signal quality feedback message which indicates a mmWave link has been established. In selected embodiments, the training control information configures the first wireless MLD to initiate multiple rounds of training PPDU sequences with same or identical transmit AWVs and configures the second wireless MLD to use different receive directional beams for the multiple rounds of training PPDU sequences. In selected embodiments, the first wireless MLD transmits the first training PPDU sequence a plurality of up to N times to the second wireless MLD through the mmWave link under control of the training control information before receiving the first signal quality feedback message, where N is a negotiated integer number of receive directional beams. In selected embodiments, the first signal quality feedback message may be initiated by the second wireless MLD via medium access on the non-mmWave link or solicited by the first wireless MLD via a beamforming polling packet on the non-mmWave link. In such embodiments, the first signal quality feedback message solicited by the first wireless MLD may be a predetermined indicator value if the second wireless MLD does not detect any packet from the first training PPDU sequence. In selected embodiments of the disclosed methodology, the first wireless MLD also receives a second training PPDU sequence from the second wireless MLD through the mmWave link under control of the training control information where there is no Tx/Rx beam reciprocity between the first and second wireless MLDs; measures a second signal quality measure based on the second training PPDU sequence received by the first wireless MLD; and transmits a second signal quality feedback message to the second wireless MLD through the non-mmWave link which includes the second signal quality measure for use by the second wireless MLD to determine the plurality of transmit antenna weight vectors (AWV) or beam ranking for analog beamforming of the second wireless MLD. In selected embodiments, the first wireless MLD transmits a plurality of up to N training PPDU sequences, including the first training PPDU sequence, to the second wireless MLD through the mmWave link under control of the training control information before receiving the first signal quality feedback message, where the first wireless MLD receives the acknowledgment response message and then waits for a first fixed time interval before transmitting the first training PPDU sequence, and where the first wireless MLD separates transmission of successive training PPDU sequences in the plurality up to N training PPDU sequences by a second fixed time interval. In such embodiments, the first wireless MLD may transmit the plurality of up to N training PPDU sequences without transmitting an announcement frame or polling packet on the non-mmWave link for each training PPDU sequence. In addition, the first fixed time interval may be a predefined Interframe space (IFS) which the second wireless MLD uses with a defined training PPDU duration, a number of Tx beams, and the second fixed time interval to calculate a switching time for switching between different directional receive beams for receiving each training PPDU sequence. In selected embodiments, the first wireless MLD receives the first signal quality feedback message from the second wireless MLD through the non-mmWave link after the first wireless MLD transmits a plurality of up to N training PPDU sequences in response to the second wireless MLD detecting and measuring a first signal quality measure based on an Nth training PPDU sequence received by the second wireless MLD on the mmWave link. In other such embodiments, the first wireless MLD applies a different transmit AWV or beam to each PPDU in the first training PPDU sequence and transmits the plurality of up to N training PPDU sequences by transmitting the first training PPDU sequence a plurality of up to N times, and where the second wireless MLD uses a different directional receive beam for receiving each training PPDU sequence in the plurality of training PPDU sequences without requiring the first wireless MLD to transmit a separate announcement frame for each training PPDU sequence.

In another form, there is provided a wireless multi-link device (MLD), system, and associated method of operation. As disclosed, the wireless MLD includes a plurality of wireless transceivers, a memory including operational instructions, and one or more processing modules operably coupled to the plurality of wireless transceivers and the memory, where the one or more processing modules are configured to execute the operational instructions to perform analog beamforming training to establish a mmWave link. In particular, the one or more processing modules are configured to execute the operational instructions for generating training control information regarding a millimeter wave (mmWave) link between the wireless MLD and a second wireless MLD, where the training control information specifies a plurality of analog beam training parameters comprising a specified number of training PPDUs, a specified transmit sector sweep (TXSS) configuration, a specified receive sector sweep (RXSS) configuration, a first indicator if the second wireless MLD includes a directional receiver, and a second indicator if the second wireless MLD includes an omni-directional receiver. In addition, the one or more processing modules are configured to execute the operational instructions for transmitting, by the wireless MLD, a first training PPDU sequence to the second wireless MLD through the mmWave link under control of the training control information. In addition, the one or more processing modules are configured to execute the operational instructions for receiving, by the wireless MLD, a first signal quality feedback message from the second wireless MLD through the non-mmWave link in response to the second wireless MLD detecting and measuring a first signal quality measure based on the first training PPDU sequence received by the second wireless MLD under control of the training control information. In this way, the wireless MLD is configured to use the first signal quality measure to determine a plurality of transmit antenna weight vectors (AWV) or beam ranking for analog beamforming of the wireless MLD. In selected embodiments, the one or more processing modules may also be configured to execute the operational instructions to generate the training control information by transmitting, by the wireless MLD, a first control frame regarding the mmWave link to the second wireless MLD through the non-mmWave link between the wireless MLD and the second wireless MLD; and receiving, by the wireless MLD, a response message sent by the second wireless MLD through the non-mmWave link in response to the second wireless MLD receiving the training control information, where information contained in the first control frame and response message are used by the wireless MLD and second wireless M LD to negotiate the training control information.

In yet another form, there is provided a wireless access point (AP) of an AP multi-link device (MLD), system, and associated method of operation for perform analog beamforming training to establish a mmWave link in accordance with IEEE 802.11 protocol. As disclosed, the wireless AP includes a MAC controller configured to generate training control management information regarding a millimeter wave (mmWave) link between the AP MLD and a non-AP MLD, wherein the mmWave link comprises a 45 Gigahertz (GHz) link or a 60 GHz link, and wherein the training control management information specifies a plurality of analog beamforming training parameters comprising a specified number of training PPDUs, a specified transmit sector sweep (TXSS) configuration, a specified receive sector sweep (RXSS) configuration, a first indicator if the non-AP MLD includes a directional receiver, and a second indicator if the non-AP MLD includes an omni-directional receiver. In addition, the disclosed the wireless AP includes a wireless transceiver configured to transmit a first training PPDU sequence to the non-AP MLD through the mmWave link under control of the training control management information, and to receive a first signal quality feedback message from the non-AP MLD through the non-mmWave link in response to the non-AP MLD detecting and measuring a first signal quality measure based on the first training PPDU sequence received by the non-AP MLD under control of the training control management information. In this way, the wireless MLD is configured to use the first signal quality measure to determine a plurality of transmit antenna weight vectors (AWV) or beam ranking for analog beamforming of the wireless MLD.

Although the described exemplary embodiments disclosed herein are directed to a wireless communication station (STA) devices which provide a multi-link operation assisted analog beam training procedure for using a non-mmWave link between first and second wireless devices to establish a mmWave link that is 802.11-compliant wireless connectivity applications and methods for operating same, the present invention is not necessarily limited to the example embodiments which illustrate inventive aspects of the present invention that are applicable to a wide variety of circuit designs and operations. Thus, the particular embodiments disclosed above are illustrative only and should not be taken as limitations upon the present invention, as the invention may be modified and practiced in different but equivalent manners apparent to those skilled in the art having the benefit of the teachings herein. Accordingly, the identification of the circuit design and configurations provided herein is merely by way of illustration and not limitation and other circuit arrangements may be used in order to implement MLO-assisted analog beam training procedures. Accordingly, the foregoing description is not intended to limit the invention to the particular form set forth, but on the contrary, is intended to cover such alternatives, modifications and equivalents as may be included within the spirit and scope of the invention as defined by the appended claims so that those skilled in the art should understand that they can make various changes, substitutions and alterations without departing from the spirit and scope of the invention in its broadest form.

At least some of the various blocks, operations, and techniques described above may be implemented utilizing hardware, a processor executing firmware instructions, a processor executing software instructions, or any combination thereof. When implemented utilizing a processor executing software or firmware instructions, the software or firmware instructions may be stored in any computer readable memory such as on a magnetic disk, an optical disk, or other storage medium, in a RAM or ROM or flash memory, processor, hard disk drive, optical disk drive, tape drive, etc. The software or firmware instructions may include machine readable instructions that, when executed by one or more processors, cause the one or more processors to perform various acts. When implemented in hardware, the hardware may comprise one or more of discrete components, an integrated circuit, an application-specific integrated circuit (ASIC), a programmable logic device (PLD), etc.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A wireless communication method for performing analog beamforming training to establish a mmWave link by a first wireless multi-link device (MLD) in accordance with Institute of Electrical and Electronics Engineers (IEEE) 802.11 protocol, comprising:
generating training control information regarding a millimeter wave (mmWave) link between the first wireless MLD and a second wireless MLD, where the training control information includes a first indicator if the second wireless MLD includes a directional receiver and includes a second indicator if the second wireless MLD includes an omni-directional receiver;
transmitting, by the first wireless MLD, a first training PPDU sequence to the second wireless MLD through the mmWave link under control of the training control information; and
receiving, by the first wireless MLD, a first signal quality feedback message from the second wireless MLD through the non-mmWave link in response to the second wireless MLD detecting and measuring a first signal quality measure based on the first training PPDU sequence received by the second wireless MLD under control of the training control information,
where the first wireless MLD uses the first signal quality measure to determine a plurality of transmit antenna weight vectors (AWV) or beam ranking for analog beamforming of the first wireless MLD.

2. The wireless communication method of claim 1, further comprising:
receiving, by the first wireless MLD, a second training PPDU sequence from the second wireless MLD through the mmWave link under control of the training control information where there is no Tx/Rx beam reciprocity between the first and second wireless MLDs;
measuring, by the first wireless MLD, a second signal quality measure based on the second training PPDU sequence received by the first wireless MLD; and
transmitting, by the first wireless MLD, a second signal quality feedback message to the second wireless MLD through the non-mmWave link which includes the second signal quality measure for use by the second wireless MLD to determine the plurality of transmit antenna weight vectors (AWV) or beam ranking for analog beamforming of the second wireless MLD.

3. The wireless communication method of claim 1, where generating the training control information comprises:
transmitting, by the first wireless MLD, a first control frame regarding the mmWave link to the second wireless MLD through the non-mmWave link between the first wireless MLD and the second wireless MLD; and
receiving, by the first wireless MLD, an acknowledgement response message sent by the second wireless MLD through the non-mmWave link in response to the second wireless MLD receiving the training control information, where information contained in the first control frame and acknowledgement response message are used by the first wireless MLD and second wireless MLD to negotiate the training control information.

4. The wireless communication method of claim 3, where the first wireless MLD transmits the first training PPDU sequence after waiting for a specified time delay after receiving the acknowledgement response message.

5. The wireless communication method of claim 4, where the specified time delay may be a predefined Interframe space (IFS) or a medium access time with random backoff based on medium status.

6. The wireless communication method of claim 1, where the training control information specifies a plurality of analog beamforming training parameters comprising a specified number of training PPDUs, a specified transmit sector sweep (TXSS) configuration, a specified receive sector sweep (RXSS) configuration, and indicator information specifying if the second wireless MLD includes an omni-directional receiver or a directional receiver.

7. The wireless communication method of claim 1, where the first wireless MLD transmits the first training PPDU sequence by applying a different transmit AWV or beam to each training PPDU in the first training PPDU sequence.

8. The wireless communication method of claim 7, where the second wireless MLD uses an omni-directional beam receiver to detect and measure the first signal quality measure from the first training PPDU sequence.

9. The wireless communication method of claim 7, where the first wireless MLD generates the first training PPDU sequence wherein each training PPDU comprises a non-training field and a training field, and where the second wireless MLD uses an omni-directional beam receiver to detect and measure only the non-training field from each training PPDU.

10. The wireless communication method of claim 9, where the second wireless MLD uses directional receive beams to measure the training field from each detected training PPDU and to determine a receive beam ranking for reverse direction Tx beam ranking when there is Tx/Rx beam reciprocity between the first and second wireless MLDs.

11. The wireless communication method of claim 7, where the second wireless MLD uses a directional beam receiver to detect and measure the first signal quality measure from the first training PPDU sequence.

12. The wireless communication method of claim 11, where the first wireless MLD uses announcement frame exchange or a polling packet to solicit the second wireless MLD to transmit the first signal quality feedback message as a reference indicator to configure different receive directional beams for the different rounds of training PPDU sequences.

13. The wireless communication method of claim 11, where the training control information configures the first wireless MLD to initiate multiple rounds of training PPDU sequences with same transmit AWVs and configures the second wireless MLD to use different receive directional beams for the multiple rounds of training PPDU sequences.

14. The wireless communication method of claim 11, where the first wireless MLD transmits the first training PPDU sequence a plurality of up to N times to the second wireless MLD through the mmWave link under control of the training control information before receiving the first signal quality feedback message, where N is a negotiated integer number of receive directional beams.

15. The wireless communication method of claim 11, where the first wireless MLD transmits the first training PPDU sequence one or more times to the second wireless MLD through the mmWave link under control of the training control information until receiving the first signal quality feedback message which indicates a mmWave link has been established.

16. The wireless communication method of claim 1, where the first signal quality feedback message may be initiated by the second wireless MLD via medium access on the non-mmWave link or solicited by the first wireless MLD via a beamforming polling packet on the non-mmWave link.

17. The wireless communication method of claim 16, where the first signal quality feedback message solicited by the first wireless MLD comprises a predetermined indicator value if the second wireless MLD does not detect any packet from the first training PPDU sequence.

18. The wireless communication method of claim 3, where the first wireless MLD transmits a plurality of up to N training PPDU sequences, including the first training PPDU sequence, to the second wireless MLD through the mmWave link under control of the training control information before receiving the first signal quality feedback message, where the first wireless MLD receives the acknowledgment response message and then waits for a first fixed time interval before transmitting the first training PPDU sequence, and where the first wireless MLD separates transmission of successive training PPDU sequences in the plurality up to N training PPDU sequences by a second fixed time interval.

19. The wireless communication method of claim 18, where the first wireless MLD transmits the plurality of up to N training PPDU sequences without transmitting an announcement frame or polling packet on the non-mmWave link for each training PPDU sequence.

20. The wireless communication method of claim 18, where the first fixed time interval is a predefined Interframe space (IFS) which the second wireless MLD uses with a defined training PPDU duration, a number of Tx beams, and the second fixed time interval to calculate a switching time for switching between different directional receive beams for receiving each training PPDU sequence.

21. The wireless communication method of claim 18, where the first wireless MLD receives the first signal quality feedback message from the second wireless MLD through the non-mmWave link after the first wireless MLD transmits a plurality of up to N training PPDU sequences in response to the second wireless MLD detecting and measuring a first signal quality measure based on an Nth training PPDU sequence received by the second wireless MLD on the mmWave link.

22. The wireless communication method of claim 18, where the first wireless MLD applies a different transmit AWV or beam to each PPDU in the first training PPDU sequence and transmits the plurality of up to N training PPDU sequences by transmitting the first training PPDU sequence a plurality of up to N times, and where the second wireless MLD uses a different directional receive beam for receiving each training PPDU sequence in the plurality of training PPDU sequences without requiring the first wireless MLD to transmit a separate announcement frame for each training PPDU sequence.

23. A wireless multi-link device (MLD) comprising:
a plurality of wireless transceivers;
memory including operational instructions; and
one or more processing modules operably coupled to the plurality of wireless transceivers and the memory,
wherein the one or more processing modules are configured to execute the operational instructions to perform analog beamforming training to establish a mmWave link by:
generating training control information regarding a millimeter wave (mmWave) link between the wireless MLD and a second wireless MLD, where the training control information specifies a plurality of analog beam training parameters comprising a specified number of training PPDUs, a specified transmit sector sweep (TXSS) configuration, a specified receive sector sweep (RXSS) configuration, a first indicator if the second wireless MLD includes a directional receiver, and a second indicator if the second wireless MLD includes an omni-directional receiver;
transmitting, by the wireless MLD, a first training PPDU sequence to the second wireless MLD through the mmWave link under control of the training control information; and
receiving, by the wireless MLD, a first signal quality feedback message from the second wireless MLD through the non-mmWave link in response to the second wireless MLD detecting and measuring a first signal quality measure based on the first training PPDU sequence received by the second wireless MLD under control of the training control information,
where the wireless MLD uses the first signal quality measure to determine a plurality of transmit antenna weight vectors (AWV) or beam ranking for analog beamforming of the wireless MLD.

24. The wireless MLD of claim 23, wherein the one or more processing modules are configured to execute the operational instructions to generate the training control information by:
transmitting, by the wireless MLD, a first control frame regarding the mmWave link to the second wireless MLD through the non-mmWave link between the wireless MLD and the second wireless MLD; and
receiving, by the wireless MLD, an response message sent by the second wireless MLD through the non-mmWave link in response to the second wireless MLD receiving the training control information, where information contained in the first control frame and response message are used by the wireless MLD and second wireless MLD to negotiate the training control information.

25. A wireless access point (AP) of an AP multi-link device (MLD) comprising:
a MAC controller configured to generate training control management information regarding a millimeter wave (mmWave) link between the AP MLD and a non-AP MLD, wherein the mmWave link comprises a 45 Gigahertz (GHz) link or a 60 GHz link, and wherein the training control management information specifies a plurality of analog beamforming training parameters comprising a specified number of training PPDUs, a specified transmit sector sweep (TXSS) configuration, a specified receive sector sweep (RXSS) configuration, a first indicator if the non-AP MLD includes a directional receiver, and a second indicator if the non-AP MLD includes an omni-directional receiver; and
a wireless transceiver configured to transmit a first training PPDU sequence to the non-AP MLD through the mmWave link under control of the training control management information, and to receive a first signal quality feedback message from the non-AP MLD through the non-mmWave link in response to the non-AP MLD detecting and measuring a first signal quality measure based on the first training PPDU sequence received by the non-AP MLD under control of the training control management information,
where the AP MLD uses the first signal quality measure to determine a plurality of transmit antenna weight vectors (AWV) or beam ranking for analog beamforming of the AP MLD.
